(19) United States
(12) Patent Application Publication
(10) Pub. No.: US 2024/0313248 A1
(43) Pub. Date: Sep. 19, 2024

(54) ELECTROCHEMICAL CELL AND METHOD FOR CARBON CAPTURE WITH ENERGY STORAGE

(71) Applicant: Volta Energy, Inc., Worcester, MA (US)

(72) Inventors: Ravindra Datta, Worcester, MA (US); Srivatsava V. Puranam, Montreal-Ouest (CA); Karan Datta, Harrow (GB)

(21) Appl. No.: 18/620,661

(22) Filed: Mar. 28, 2024

Related U.S. Application Data
(63) Continuation-in-part of application No. 17/535,290, filed on Nov. 24, 2021, now Pat. No. 11,949,139.
(60) Provisional application No. 63/119,058, filed on Nov. 30, 2020.

(51) Int. Cl. H01M 8/18; H01M 8/04082; H01M 8/04186; H01M 8/0668

(52) U.S. Cl. CPC H01M 8/188; H01M 8/04186; H01M 8/0668; H01M 8/04201

(57) ABSTRACT

Described are flow electrochemical cells and systems using flow electrochemical cells that carry simultaneous CO₂ capture and electrical energy storage. The flow electrochemical cells comprise a negative electrode configured to be in fluid communication with alkaline negative electrolyte, a positive electrode configured to be in fluid communication with acidic positive electrolyte, a first ion-exchange membrane in contact with the negative electrode, a second ion-exchange membrane in contact with the positive electrode, and an inert intermediate neutralyte layer between the first ion-exchange membrane and the second ion-exchange membrane.

### RELATED APPLICATIONS

This patent application is a Continuation-in-Part (CIP) of U.S. patent application Ser. No. 17/535,290, filed Nov. 24, 2021, entitled “ELECTROCHEMICAL CELL AND METHOD FOR CARBON CAPTURE WITH ENERGY STORAGE,” now U.S. Pat. No. 11,949,139, which claims the benefit under 35 U.S.C. § 119(e) of U.S. Provisional Patent App. No. 63/119,058, filed Nov. 30, 2020, entitled “ELECTROCHEMICAL CELL AND METHOD FOR CARBON CAPTURE WITH ENERGY STORAGE,” both incorporated herein by reference in entirety.

### FIELD OF THE INVENTION

This disclosure relates to systems and methods of simultaneous carbon capture and energy storage.

### BACKGROUND

The electrical energy sector is undergoing a seismic shift to clean energy. The International Energy Agency report on a roadmap to net zero carbon emissions by 2050 envisions fundamental changes in the rapidly growing global electric energy sector, currently the single largest source of CO₂ emissions. It is expected that there will be: 1) a dramatic growth in solar and wind power, which owing to their variable power generation need to be paired with electrical energy storage, 2) a phasing out of the least-efficient coal plants, and 3) retrofitting of the remaining coal- and natural gas-fired plants for post-combustion carbon capture utilization and storage. In other words, carbon capture and storage and electrical energy storage are the two pillars that will allow the realization of a net-zero electric power sector.

The International Energy Agency expects that there will be a dramatic growth in electric power generation from the current 23,230 TWh to roughly 60,000 TWh by 2050. This is in part due to electrification of the other large energy consuming sectors, e.g., transportation, housing, and manufacturing. It is further expected that 70% of the global electric power by 2050 will be generated via wind and solar power. Because of the intermittent nature of these renewable generators there is expected to be a concomitant growth in grid-scale battery energy storage, including that based on redox flow batteries (RFBs), so that the temporal differences between energy generation and energy demand can be leveled out.

It is expected that a significant fraction of electric power will continue to be generated in fossil-fueled plants, e.g., in natural gas combined cycle (NGCC) power plants that are retrofitted with a carbon capture (CC) plant to reduce their CO₂ emissions. The abated NGCC plants may play a prominent role for a number of reasons. These include the abundant natural gas supply at a low price, a lower carbon footprint than other fossil fuels such as coal, and the fact that the modern NGCC plant designs are highly efficient and, unlike coal and nuclear plants, can rapidly ramp up or down to accommodate grid variability, which is expected to be further exacerbated with the anticipated exponential growth of the renewable (but intermittent) generators.

### SUMMARY

Disclosed are electrochemical cells and methods that allow a combination of electrochemical energy storage (eES) and electrochemical carbon capture (eCC). An efficient and scalable carbon-capturing redox-flow battery (CC-RFB) is described that synergistically combines electrical energy storage and grid arbitrage with capture of carbon-dioxide either directly from air or from a point source such as a flue gas from a power generating or a manufacturing plant. The captured pure carbon-dioxide is suitable for compression, transportation, and geological storage, or as an industrial feedstock. The CC-RFB cell is powered by renewable electricity generators, fossil-fuel power plants, or directly from the grid for energy storage. The CC-RFB cell electrochemically maintains a pH differential between two electrodes via a uniquely structured membrane-electrode assembly (MEA) that boosts the cell voltage dramatically to provide efficient energy storage with high areal power densities.

The CC-RFB accomplishes the twin objectives of efficient carbon-dioxide capture and electrical energy storage in a single electrochemical cell by creating an internal pH differential maintained via a novel process and cell structure that contains two porous electrodes, with or without an appropriate catalyst, that flank a three-layer assembly consisting of an intermediate neutralye layer (NL) sandwiched between two ion-exchange membranes (IEMs) for selective transport of cations and/or anions. The CC-RFB maintains electrolyte at the negative electrode at a high pH needed to efficiently absorb carbon-dioxide in situ or in a separate absorber, and at the positive electrode at a low pH, so that the absorbed carbon-dioxide may be released as a pure gas in the NL. The pH differential further enhances the cell potential and power density for cost-effective energy storage.

The two electrolytes may contain distinct or the same redox-active species to facilitate electron transfer reactions at the electrodes. These redox-active species are refreshed chemically or electrochemically, the latter in the discharge phase in a reverse process when the cell produces power, supplying it either to recharge the cells or supplying it back to the grid. In some embodiments, the individual CC-RFB cells are arranged and operated in stacks.

One example of a net-negative application of the CC-RFB cell is in conjunction with a solar cell plant or a windmill farm, where it provides the requisite energy storage to overcome the variability of these renewable power generators, and concomitantly accomplishes direct air capture of CO₂. In another carbon-neutral example of its application, the CC-RFB replaces the conventional amine-based plant for capture of CO₂ from the flue gas of an NGCC power plant while providing grid-scale energy storage, allowing the NGCC plant to operate under steady and optimal conditions and increasing its efficiency while enhancing profitability via arbitrage. A third example is carbon capture from the exhaust of a carbon intensive manufacturing plant such as a cement kiln, blast furnace, or fermentation ethanol plant, and simultaneously providing large-scale electrical energy storage of renewable or fossil energy for use within the manufacturing process and/or for supporting the increasing grid variability. The scale of such applications can vary over several orders of magnitude.

In further detail, example configurations below depict a flow electrochemical cell with a negative electrode configured to be in fluid communication with alkaline negative electrolyte, and a positive electrode configured to be in fluid communication with acidic positive electrolyte. The flow electrochemical cell also includes a first ion-exchange membrane in contact with the negative electrode, and a second ion-exchange membrane in contact with the positive electrode. An inert intermediate neutralyte layer between the first ion-exchange membrane and the second ion-exchange membrane is configured to maintain a pH differential between the negative electrode and the positive electrode.

The described electrochemical negative emissions technology not only reduces emissions by directly removing carbon dioxide from air, or from the exhaust streams of power generation and manufacturing plants, but also indirectly by allowing the power generation to become more efficient and renewable via grid level electricity storage.

### BRIEF DESCRIPTION OF THE DRAWINGS

FIG. 1 is a schematic of a CC-RFB electrochemical carbon capture and energy storage cell in charge/carbon capture mode.

FIG. 2 is a schematic of a plant showing an absorber for absorbing CO₂ and electrochemical CC-RFB cells as described in FIG. 1 in stacks.

FIG. 3 is a diagram of a reaction of produced bicarbonate with proton to release a CO_{2,p} product at a low pH and a diagram of the reaction of electrophilic CO_{2,f} in feed with a nucleophilic hydroxyl ion, OH⁻, in a high pH electrolyte showing transfer of electrons.

FIG. 4 is a diagram showing the Gibbs free energy landscape for CO₂ sorption and separation.

FIG. 5 is a graph showing the effect of pH on the fraction of carbon species in aqueous solutions at 25° C.

FIG. 6 is a Pourbaix diagram for an H₂—O₂ system, plotting the electrode equilibrium potential the hydrogen evolution reaction and that for the oxygen evolution reaction as a function of pH, along with some exemplary redox couples.

FIG. 7 shows examples of redox couples based on transition metal coordination compounds for (a) Aqua vanadium ions, VO₂⁺/VO²⁺, for the case of an acidic solution charge-transfer cation A⁺=H⁺, and (b) ferrocyanate in an alkaline solution with A⁺=K⁺ counterions.

FIG. 8 is an example schematic of an embodiment of a CC-RFB cell.

FIGS. 9a and 9b are example schematics of an embodiment of a CC-RFB cell.

FIG. 10 is an example schematic of an embodiment of a CC-RFB cell.

FIG. 11 is an example schematic of an embodiment of a CC-RFB cell for combined electrochemical carbon capture and energy storage based on a vanadium redox flow battery (VRFB), shown in CC/charge mode.

FIG. 12 is a polarization plot for discharge mode for a cell with and without a pH differential for a state of charge=50%.

FIG. 13 is a plot showing a comparison of discharge power density in a conventional VRFB versus that in a VRFB with a pH differential.

FIG. 14 is a plot of the efficiency of a cell configured for direct air capture as a function of current density.

FIG. 15 is a schematic of an embodiment of a CC-RFB cell with two CEMs and using oxygen electrode reaction at the positive electrode.

FIG. 16 is a schematic of an embodiment of a CC-RFB cell for continuous carbon capture using O₂ from air and water.

FIG. 17 is a schematic of another embodiment of a CC-RFB cell for continuous carbon capture using O₂ from air and water.

FIG. 18 of an embodiment of a CC-RFB cell for continuous carbon capture with no redox species except H₂.

FIG. 19 of an embodiment of a CC-RFB cell powered by a fuel and an oxidant and producing power while capturing carbon.

FIG. 20 is an alternative configuration employing a single ion-exchange membrane is employed in the membrane-electrode assembly (MEA).

FIG. 21 shows an alternative configuration employing a single ion-exchange membrane is employed in the membrane-electrode assembly (MEA) adjacent the negative electrolyte membrane-electrode assembly (MEA).

FIG. 22 shows a configuration where the neutralyte is formed from a porous catalytic material to produce a chemical or fuel.

FIG. 23 shows a single ion exchange membrane (IEM) in conjunction with a neutralyte formed from a porous electrocatalytic material.

FIG. 24 shows an enhancement wherein the negolyte and the neutralyte are distinct electrolytes and the negolyte is not in fluid communication with gas-liquid CO₂ absorber;

FIG. 25 shows an approach employing 2 opposed ion-exchange membranes and adapted for use exclusively for energy storage (ES) without carbon capture (CC).

FIG. 26 shows a variation of the approach of FIG. 1 without a separate neutralyte and used exclusively for energy storage (ES) without carbon capture (CC).

FIG. 27 shows a configuration as in FIG. 26 with only a single ion-exchange membrane, also used exclusively for energy storage (ES) or as a flow battery without carbon capture (CC).

FIG. 28 shows a polarization plot of an all-iron redox flow battery device at various states of charge (soc) during charge (ch) and discharge (dc) phases.

### DETAILED DESCRIPTION

Disclosed are electrochemical cells and methods that allow a combination of electrochemical energy storage (eES) and electrochemical carbon capture (eCC). An efficient and scalable carbon-capturing redox-flow battery (CC-RFB) is described that synergistically combines electrical energy storage and grid arbitrage with capture of carbon-dioxide either directly from air or from a point source such as a flue gas from a power generating or a manufacturing plant. The captured pure carbon-dioxide is suitable for compression, transportation, and geological storage, or as an industrial feedstock. The CC-RFB cell is powered by renewable electricity generators, fossil-fuel power plants, or directly from the grid for energy storage. The CC-RFB cell electrochemically maintains a pH differential between two electrodes via a uniquely structured membrane-electrode assembly (MEA) that boosts the cell voltage dramatically to provide efficient energy storage with high areal power densities.

The alkaline electrolyte (e.g., the negative electrolyte or negolyte) is able to remove as much as 75% CO₂ directly from air, or up to 99% of CO₂ from flue gas of a chemical or a power plant in a packed gas-liquid contactor. The captured CO₂ is released in the CC-RFB cell stack powered by an external source such as a NGCC power plant or a solar/wind generator. Simultaneously, the cell gets charged by restoring the soc of the active redox component, as in an RFB. Once fully charged, the cell can be used in the discharge mode to power the grid or provide part of the power needed by stacks in the eCC mode, with the remaining coming from the power generator. Because of the cell internal irreversibilities and the resultant losses, supplemental auxiliary power is needed from the associated fossil or renewable power plant/grid even if all of the stored power is returned. The relative fraction of the auxiliary to battery power is varied depending on the grid demand and pricing, and the saved energy sold at a higher price during periods of higher demand. Such energy arbitrage can be an attractive component of the system economic viability.

### System Description

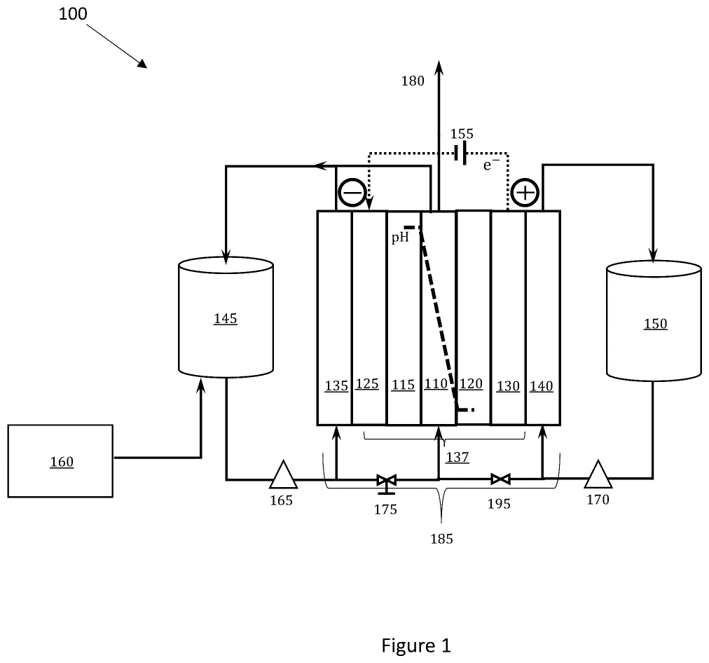

FIG. 1 illustrates the components of a CC-RFB cell 100 that combines CO₂ capture (CC) and energy storage (ES) in the same electrochemical cell. A central neutralyte layer (NL) 110 carries out an acid-base reaction and CO₂ release. The NL layer 110 is sandwiched between a first ion-exchange membrane or IEM1 115 and a second ion-exchange membrane or IEM2 120.

IEM1 115, the neutralyte layer 110 and IEM2 120 are interposed between a negative electrode 125 and a positive electrode 130, forming a five-layer membrane-electrode assembly (MEA) 137. The MEA 137 is denoted as ⊖-IEM1-NL-IEM2-@, referring in order to the negative electrode 125, IEM1 115, the NL 110, IEM2 120, and the positive electrode 130. The MEA 137 is placed between two bipolar plates with electrolyte flow distribution channels, an alkaline negolyte chamber 135 on the negative side of the cell and an acidic positive electrolyte or posolyte chamber 140 on the other side. The MEA 137 and two chambers 135, 140 together form a reactor unit 185. The arrangement with two IEMs 115, 120 sandwiching the NL 110 allows increase and decrease of the pH between the electrolytes without their intermingling, as depicted in FIG. 1.

The alkaline negolyte chamber 135 is in fluid communication with a carbonated alkaline negolyte tank 145 via a pump 165 configured to transport the negolyte fluid therebetween. The acidic posolyte chamber 140 is in fluid communication with an acidic posolyte tank 150 via second pump 170 configured to transport the posolyte fluid therebetween.

Via the alkaline negolyte chamber 135 and acidic posolyte chamber 140, the respective electrodes 125, 130 are in external fluid communication with sources of redox molecules for each electrode 125, 130; a posolyte for the positive electrode 135, and a negolyte for the negative electrode 125. The negolyte contains ions bearing CO₂ captured in an external gas-liquid absorber 160. The gas-liquid absorber 160 contains the same negolyte as in the negolyte tank 145, and captures CO₂ therein (e.g., through bubbling CO₂ through the liquid negolyte). CO₂ bearing electrolytes accordingly are in fluid communication between the absorber 160 that acts as an upstream source for the negolyte tank 145. In some embodiments, the gas-liquid absorber 160 and the negolyte tank 145 are combined.

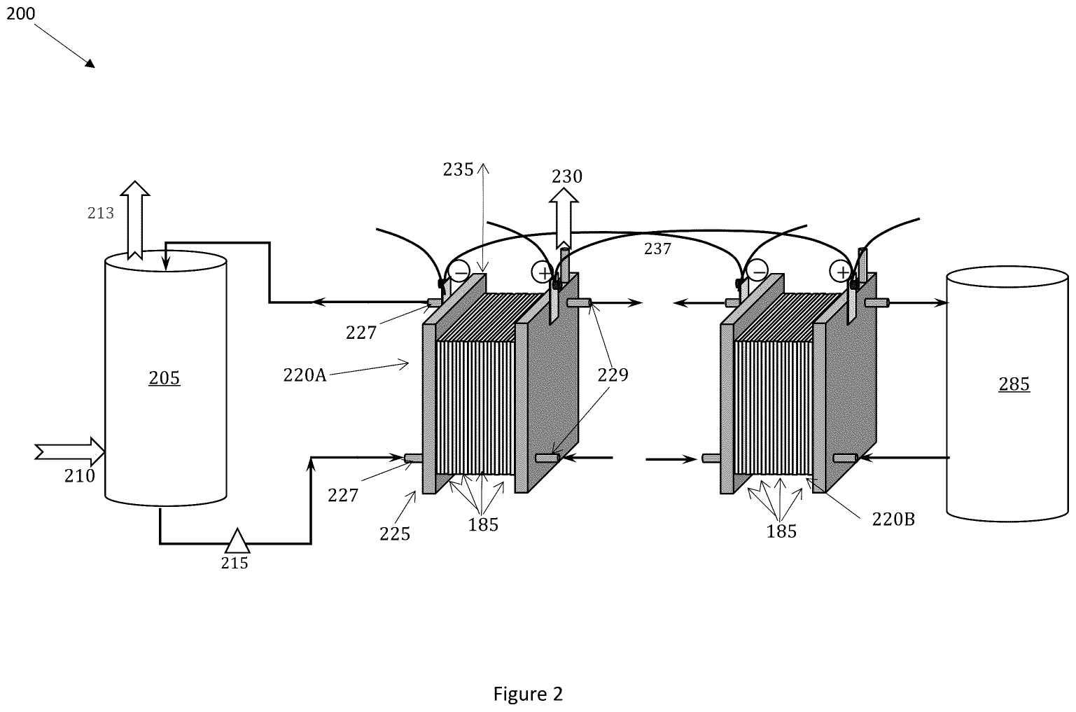

The CC-RFB cell 100 (e.g., the reactor unit 185) is in external electronic communication with an energy source and energy sink, denoted generally as load 155. When the CC-RFB cell 100 is in a discharging mode, the load 155 acts as an energy sink, receiving energy stored within the CC-RFB cell 100. For example, the load 155 can be a single device, or an electrical grid in the case of a large-scale CC-RFB unit (described below with respect to FIG. 2). When the CC-RFB cell 100 is in charging mode, the load 155 supplies energy to the CC-RFB cell 100 to drive the electron transfer and the ion transport processes necessary to maintain the desired pH differential across the MEA 137. For example, the load 155 when in charge mode can be a renewable or fossil-fueled electric energy source. Alternatively, the chemical energy of a fuel, e.g., hydrogen, and/or an oxidant, e.g., oxygen, can drive the process.

Concerning the electrochemical capture of CO₂, the CC-RFB cell 100 uses a spatial pH differential for the segregation of absorption and desorption steps of CO₂ with the use of a unique cell structure of ⊖-IEM1-NL-IEM2-⊕ for the MEA 137. Such a structure has not so far been used for electrochemical CO₂ capture.

IEM combinations for sandwiching the NL 110 can include a combination of a cation-exchange membrane (CEM) and an anion-exchange membrane (AEM). The CC-RFB cells disclosed herein use combinations not known so far, e.g., an ⊖-AEM1-NL-AEM2-⊕, and a ⊖-CEM1-NL-CEM2-⊕ combination for the MEA 137. The latter combination is especially effective in the design of a cell with low internal resistance and excellent performance, along with a long cell life, as CEMs have higher conductivities than AEMs, are more durable, and are commercially better developed. While bipolar membranes can also in principle maintain a pH differential across it, that requires the use of energetically demanding water dissociation at the interface to maintain it.

The MEA 137 can have different possible combinations of for the different ⊖-IEM1-NL-IEM2-⊕ components. These combinations include a) a ⊖-AEM1-NL-CEM2-⊕ combination; b) a ⊖-CEM1-NL-AEM2-⊕ combination; c) a ⊖-CEM1-NL-CEM2-⊕ combination; and d) a ⊖-AEM1-NL-AEM2-⊕ combination. In other words, there are two possible arrangements for the mixed IEM case (cases (a) and (b)), depending on their placement adjacent to a given electrode (positive or negative). Further, the physical and transport characteristics of CEM1 and CEM2, or AEM1 and AEM2 in cases (c) and (d) may be different depending on the nature of the ions involved.

The electron transfer reactions during discharge at the negative electrode 125 result in the generation of the OH⁻ nucleophile in the negolyte, according to

O₋+A⁺OH⁻+e⁻⇄R₋+OH⁻

where the cation A⁺=Na⁺, K⁺, Li⁺, etc., for basic electrolytes. As a result of the generation of the hydroxyl ion, there is an increase in the pH of the negolyte, thus facilitating CO₂ capture, e.g., in a sparged packed column contactor, or in a tank like tank 145, or even directly at the negative electrode 125. The reaction results in the formation of bicarbonate and carbonate anions, as described by the reactions:

OH⁻+CO₂⇄HCO₃⁻

OH⁻+HCO₃⁻⇄CO₃²⁻+H₂O

The resulting CO₂ bearing bicarbonate and carbonate anions are transported to the NL 110, the nature of the transport step depending upon the identity of IEM1 115; e.g., whether an AEM or a CEM is placed adjacent to the negative electrode 125 to form IEM1 115. In the case that IEM1 115 is an AEM, the anions can directly and selectively migrate across IEM1 115 from the negative electrode 125 to the NL 110 under the influence of an externally imposed electric field. If IEM1 115 is a CEM, then since the anions are precluded from it, the CO₂ enriched solution must be transported to the NL 110 via physical transport, such as with the assistance of the pump 165 and a valve 175 to control the flow rate. The result is that cations A⁺ also accompany the bicarbonate and the carbonate anions to the NL 10. Subsequently, these are returned to the negative electrode 125 via selective cation migration through the CEM (that is in the place of the IEM1 115). The configuration of the ion-exchange membranes also determines whether the ions involved in the electrode reactions are also involved in charge transfer across the membrane, or whether this is accomplished by the counterions in the electrolyte or supporting electrolyte. In other words, the charge transfer ions are not limited to those OH⁻, HCO₃⁻, CO₃²⁻, and H⁺, but can also be those in the supporting electrolyte. This allows for a great degree of freedom in determining the CC-RFB cell 100 design and the nature of the electrode and transport processes.

The net result in either scheme is the transport of CO₂-bearing anions to the NL 110, where they encounter protons arriving from the positive electrode. Thus, the reactions in the NL 110 resulting in the release of CO₂ are:

H⁺+CO₃²⁻⇄HCO₃⁻

H⁺+HCO₃⁻⇄H₂O+CO₂

In addition, acid-base neutralization reactions can occur, namely, OH⁻+H⁺⇄H₂O. The protons needed for acidification and the consequent release of CO₂ in the NL are replenished at the positive electrode via the reaction

R₊⇄O₊+H⁺+e⁻

and are similarly transported to the NL 110 either via migration or convection depending on the nature of IEM2 120. When IEM2 120 adjacent to the positive electrode 130 is a CEM, H⁺ can directly migrate across IEM2 120 to the NL 110. If IEM2 120 is an AEM, then the acidified solution at the positive electrode 130 must be transported to the NL 110 via convection, by opening valve 195 and with the help of a pump 170, also accompanied by counter anions, which are then returned to the chamber 140 via ion migration across the AEM that forms IEM2 120.

Alkalinity is restored in the negolyte during charge mode via electrochemical generation of OH⁻ ions, and acidity in the posolyte via generation of protons, H⁺. The restored alkaline negolyte is then used to capture CO₂ from a point source, or from air, in a separate absorber 160 or within the CC-RFB, and the resulting CO₂-bearing anions are eventually transported to the NL 110 where they bind with protons under the prevailing acidic conditions, releasing the CO₂ as a pure gas, e.g., via outlet 180.

Because of the finite capacity of the negolyte tank 145 and posolyte tank 150, the state of charge (soc) of the active components in the negolyte and the posolyte changes with time, as would the efficacy of the device for CC and ES. Thereafter, steps must be taken to restore the redox molecules to their original state. This can be accomplished either chemically, or more conveniently electrochemically in the same cell, by simply reversing the process, or by operating the cell in discharge mode, and in the absence of CO₂ generation, when it can produce power that may be used for a variety of purposes, including grid arbitrage.

During the discharge cycle of such a cell, since CO₂ is not involved, the reactions are limited, e.g., to the following

| Electrode | Reaction |
|---|---|
| Negative, | R_ + OH⁻ [symbol] O_ + AOH + e⁻ |
| NL, | H₂O [symbol] H⁺ + OH⁻ |
| Positive, | O₊ + H⁺ + e⁻ [symbol] R₊ |
| Cell OR: | R_ + H₂O + O₊ [symbol] O_ + AOH + R₊ |

The relative significant of the CC and energy storage functions of the device for a particular application can be tailored by choosing appropriate redox couples and the resulting cell voltage. If the goal were, for instance, to couple significant energy storage function with carbon capture in the cell, then selection of the redox couples should be such that the cell voltage of the selected redox pairs is high, as further enhanced by the pH differential. In some embodiments, a cell has a voltage that exceeds roughly 1.5-1.6 V, which is typically the limit in aqueous systems if one wishes to avoid water splitting and the resulting oxygen evolution reaction (OER) and/or the hydrogen evolution reaction (HER) at either electrode. In some embodiments, cell voltage as high as 2 V is possible in the CC-RFB cell 100 with a pH differential.

FIG. 2 shows a plant arrangement 200 using multiple CC-RFB cells 100 as described in FIG. 1. In the plant arrangement 200 a CO₂ absorber 205 receives flue gas or air via an inlet 210 and stores CO₂, with decarbonized flue gas or air exiting via outlet 213. The absorber 205 can also act as the negolyte tank 145 described with respect to FIG. 1. CO₂ and negolyte are transferred (e.g., via a pump 215) to a stack 220A. The stack 220A is made up of a plurality of reactor units 185 such as described with respect to FIG. 1. Each reactor unit 185 is configured to carry out energy storage and CO₂ capture.

The stack 220A includes a fluidic housing 225. The fluidic housing 225 contains the reactor units 185 therein, conducts negolyte into and out of the stack 220A (e.g., to and from the absorber 205 or a negolyte tank) via negolyte ports 227 and conducts posolyte into and out of the stack 220A via posolyte ports 229 to and from a posolyte tank 285. The fluidic housing 225 also conducts CO₂ out of the stack 220A (via an outlet 230) and conducts electrical charge into or out of the stack 220A to/from load 235 according to if the stack 220A is being charged or discharged.

The plant arrangement 200 can include a second stack 220B. Two stacks 220A, 220B are shown in FIG. 2 but three, four, ten, or more stacks are possible. In some embodiments, the second stack 220B can be in communication with the same absorber 205 as is stack 220A and/or the same posolyte source as is stack 221A. In some embodiments, the second stack 220B or can be in communication with a different absorber and/or fluid tanks. In some embodiments, the first stack 220A can be electrically connected to the second stack 220B via electrical connections 237. Electrical connections allow electrical communication between the stacks 220A, 220B. For example, the first stack 220A can be charged from the load 235 and then the stored charge transferred to the second stack 220B (e.g., the first stack 220A can be used to charge the second stack 220B). In some embodiments, some stacks in the plant arrangement 200 can be in energy storage mode while other stacks are in discharging mode, and some stacks can be capturing CO₂ and some stacks not.

### Scientific Basis

The separation of CO₂ from air or from a point source generally involves the following steps: 1) CO₂ capture from the dilute gas using an absorbent solution or an adsorbent solid, 2) release of concentrated CO₂ from the absorbent/adsorbent via a thermal, pressure, chemical, or electrochemical swing, 3) compression, and 4) geological storage, or further processing.

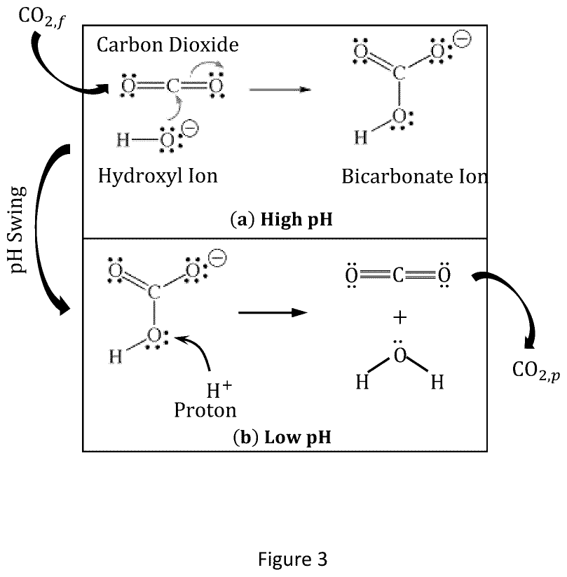

For the absorption/adsorption step, the underlying chemical scheme shown in FIG. 3 (top portion) exploits the fact that the carbon in CO₂ is electrophilic, or electron-loving, and binds to nucleophilic, i.e., positive charge loving, species. For example, the hydroxyl ion, OH⁻ in a high pH aqueous electrolyte solution, which has an excess electron density on its oxygen, and readily reacts with CO₂, forming a C—O bond and resulting in a bicarbonate ion, as shown schematically in Figure x1(a), which in solution is counterbalanced with a cationic species generically denoted here as A⁺. For instance, A⁺=H⁺, Li⁺, Na⁺, K⁺, etc.

For the recovery step, if the CO₂-bearing bicarbonate anion is next exposed to acidic conditions, or a lower pH, the strongly electrophilic proton binds with the nucleophilic oxygen in the OH group forming water and releasing the CO₂, as shown in FIG. 3 (the bottom portion of the figure). A pH swing can, thus, be used to capture CO₂. This principle is utilized in the CC-RFB cell by electrochemically generating the pH swing.

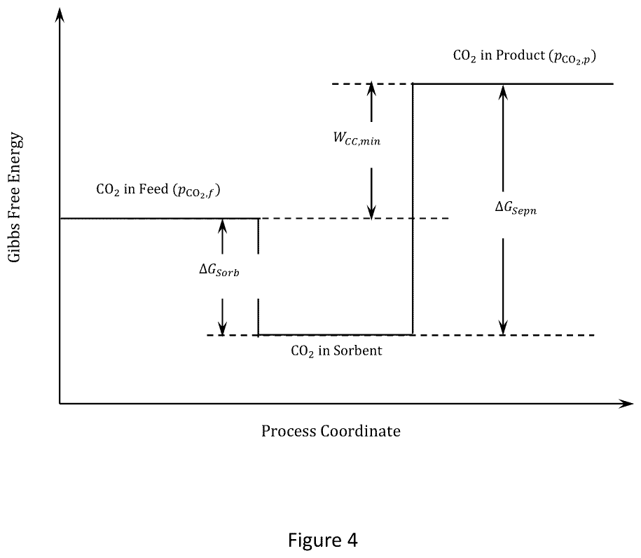

As depicted in FIG. 4, the CO₂ absorption/adsorption step is exothermic and exergonic, or spontaneous, while the subsequent stripping step is endothermic and endergonic, thus requiring expenditure of energy, more so for sorbents with stronger affinity for CO₂. The choice of sorbent material needed is dependent also on the strength of the CO₂ source. Thus, stronger reagents, e.g., alkali solutions of NaOH, KOH, LiOH, etc., are required for treating very dilute sources such as ambient air or in a space capsule, but then recovery of CO₂ from the resulting strongly bound compounds becomes correspondingly more challenging. For more concentrated sources of CO₂ such as a flue gas, amine solutions are adequately strong for absorption.

The minimum thermodynamic work of carbon capture, from a source with a CO₂ partial pressure of p_{CO}_{₂}_{,f} to a product with p_{CO}_{₂}_{,p}, is

$${W}_{CC , min} = \frac{R T}{M {W}_{{CO}_{2}}} ln ( \frac{{p}_{C {O}_{2} , p}}{{p}_{C {O}_{2} , f}} ) = \text{} \frac{8.314 \times 298}{44} ln ( \frac{1}{0.00041} ) = 0.44 GJ {t}^{- 1} {CO}_{2} = 0.12 MWh {t}^{- 1} {CO}_{2}$$

where R is the gas constant, T the temperature, and MW_{CO}_{₂} is the molecular weight of CO₂. The calculation for minimum work of producing pure CO₂ from ambient air with a mole fraction x_{CO}_{₂}=410 ppm is provided above as an example. The dilute conditions in air recommend the use of a sorbent with a strong affinity.

The electrochemical carbon capture methods, in general, rely on regenerating the nucleophilic and electrophilic species, e.g., OH⁻ and H⁺ ions, electrochemically, so that they can again in the next cycle participate to capture and subsequently release CO₂. The nature of the active species depends on the electrolyte phase, i.e., whether it is an aqueous or a nonaqueous phase. In the former, e.g., the nucleophile that binds to CO₂ is almost invariably the OH⁻ ion, while in the latter it can vary.

Unlike traditional batteries, RFBs are more akin to regenerative fuel cells, in which the electrical energy is stored as the chemical energy of redox active materials contained in a liquid solution that also contains the charge transfer ions. Unlike traditional batteries where the active materials are stored within the cell, the electrolyte solution in RFBs is stored externally in tanks and simply flows in and out of a rechargeable cell. Thus, the power and energy capacity of an RFB energy storage system are decoupled, offering design flexibility and potentially lower costs by optimizing power versus storage capacity.

The RFB is, thus, composed of two half-cells, each with its own redox-active couple, R₊/O₊, and R₋/O₋, the subscripts referring to the positive and negative electrodes, respectively, which cycles between its two different oxidation states, e.g., R₋ and O₋, via facile and reversible electrode reactions. The electrode and the cell overall reactions (ORs) are of the general form

| | |
|---|---|
| −ve: | R_ [symbol] O_ + nA⁺ + ne⁻ |
| +ve: | O₊ + nA⁺ + ne⁻ [symbol] R₊ |
| Cell: | R_ + O₊ [symbol] O_ + R₊ |

written for a cell in discharge mode, and in the reverse direction for the charge mode. The above scheme is based on cations (A⁺=H⁺, Li⁺, Na⁺, K⁺, etc.) as the charge transfer ion between the two electrodes separated by a CEM, which allows their selective transport between the negolyte and the posolyte, the electrolyte solutions at the negative and positive electrodes, respectively, while electrons are exchanged between the two via external circuit. Alternately, anions may be used as the charge transfer ions based on the use of an AEM separating the two RFB electrodes and the corresponding electrolytes.

The effect of pH on CO₂ dissolution and subsequent evolution may be quantified based on the pH-dependent thermodynamics of CO₂ capture steps: 1) dissolution (Henry's Law), and the subsequent formation of 2) bicarbonate and 3) carbonate ions, i.e.,

$${CO}_{2} ( g ) {\to }_{←} {CO}_{2} ( aq ) ; {κ}_{C {O}_{2}} = \frac{{c}_{{CO}_{2} ( a q )}}{{c}_{C {O}_{2} ( g )}} = 0.83$$

$${CO}_{2} ( a q ) + {H}_{2} O {\to }_{←} {H}^{+} + {HCO}_{3}^{-} ; {K}_{a 1} = \frac{{c}_{{HCO}_{3}} - {a}_{{H}^{+}}}{{c}_{C {O}_{2} ( a q )}} = {10}^{- 6.35}$$

$${HCO}_{3}^{-} {\to }_{←} {H}^{+} + {CO}_{3}^{2 -} ; {K}_{a 2} = \frac{{c}_{C {O}_{3}^{2}} - {a}_{{H}^{+}}}{{c}_{H C {O}_{3}^{-}}} = {10}^{- 10.33}$$

where the values of the partition coefficient of dissolution, κ_{CO}_{₂}, and the equilibrium constants for the subsequent ionization steps, Kₐ₁ and Kₐ₂, are given at 25° C.

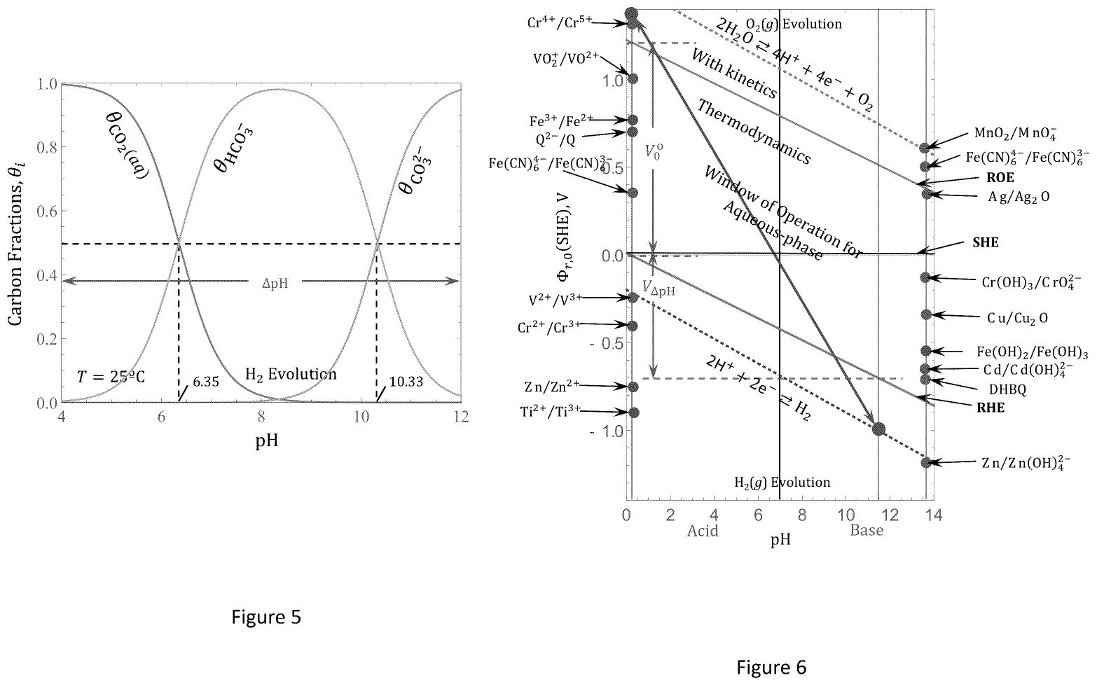

FIG. 5 shows the fraction of the different carbon species to total dissolved carbon in solution are plotted using these relations. It is seen that when pH<4, or under acidic conditions, CO₂ is present simply as a dissolved gas, CO₂(aq). As pH increases, bicarbonate ion, HCO₃⁻, is first formed, peaking at a pH of roughly 9. As the pH increases further, or under strongly alkaline conditions, carbonate ion, CO₃²⁻, becomes predominant. It is further evident that a pH differential in the range of roughly ≤4 and ≥11 is desirable for the release and solution of CO₂, respectively. This is the basis of the release of the captured CO₂ as a pure gas in the NL, where the pH is lower due to protonation. The CC-RFB cell sustains the pH differential with an IEM-NL-IEM sandwich, which has not been done so far.

The pH differential needed in the cell for electrochemical carbon capture is additionally exploited to enhance energy storage in the CC-RFB by significantly enhancing its potential. The basis for this provided in FIG. 6, which plots a Pourbaix diagram for the H₂—O₂ system, i.e., the standard electrode equilibrium potential for the hydrogen electrode reaction (HER), and that for the oxygen electrode reaction (OER), as a function of pH, which can be obtained from the Nernst equation.

Thus, the Nernst potential for the negative electrode

$${Φ}_{- , 0} = {( {Φ}_{- , 0}^{o} )}_{p H = 0} + \frac{R T}{n F} ln ( \frac{1 - soc\_}{soc\_} ) - 2.3 \; 026 ( \frac{R T}{F} ) pH\_$$

while that for the positive electrode

$${Φ}_{+ , 0} = {( {Φ}_{+ , 0}^{o} )}_{p H = 0} + \frac{R T}{n F} ln ( \frac{s o {c}_{+}}{1 - s o {c}_{+}} ) - 2.3 \; 026 ( \frac{R T}{F} ) {pH}_{+}$$

where n is the number of electrons transferred in the electrode reaction.

Consequently, the equilibrium Nernst potential of a cell comprising of the two electrodes or half cells, V₀=Φ_{+,0}−Φ_{-,0}, along with assuming that soc₊=soc₋=soc, during discharge (denoted via a forward arrow, →), thus, is

$${\vec{V}}_{0} = {( {V}_{0}^{o} )}_{p H = 0} + \frac{R T}{n F} ln {( \frac{s o c}{1 - s o c} )}^{2} + {V}_{Δ p H}$$

where the standard cell potential at pH=0, (V₀^{o})_{pH=0}=(Φ_{+,0}^{o})_{pH=0}−(Φ_{-,0}^{o})_{pH=0}, while the additional cell potential due to the pH differential

$${V}_{Δ p H} = 2.3 \; 026 ( \frac{R T}{F} ) ( pH\_ - {pH}_{+} )$$

For example, for the H₂—O₂ system (FIG. 6) at 298 K, the standard cell potential, (V₀^{o})_{pH=0}=1.229 V, while the potential change due to pH differential for pH₋=0, and pH₊=14,

$${V}_{Δ p H} = 2.3 \; 026 ( \frac{8.314 \times 298}{96 , 485} ) ( 14 - 0 ) = 0.8 \; 28 V$$

In other words, the voltage of a cell may be boosted by as much as 800 mV via an appropriate pH differential between an alkaline negative electrode and an acidic positive electrode, as indicated schematically by the diagonal line in FIG. 6.

This principle applies not just to the H₂—O₂ cell but to pH dependence of other redox chemistries as well, as described by their respective Pourbaix diagrams. However, the individual redox couples for the negative and positive electrode in aqueous electrolyte batteries are chosen such that water electrolysis and the resulting hydrogen evolution reaction (HER) at the negative electrode, and the oxygen evolution reaction (OER) at the positive electrode may be avoided.

Thus, the shaded region in FIG. 6 indicates the window of operation as limited by this need to avoid water electrolysis, including roughly the kinetic overpotentials beyond the equilibrium potentials for HER and OER. Any redox couple(s) chosen for the cell must be adequately soluble and remain at the chosen pH. In addition, the redox couple chosen for the negative electrode must not be overly sensitive to oxygen, to which the negolyte is copiously exposed in the CO₂ absorber.

As mentioned above, while there are a handful of RFB reports in the literature that seek to thus exploit a pH differential to boost the cell voltage, they invariably employ a ⊖-CEM-NL-AEM-⊕ combination, or a bipolar membrane (BPM) with a similar configuration of its layers. Our approach is more general and involves other ⊖-IEM1-NL-IEM2-⊕ combinations, including twin CEMs, or twin AEMs.

Finally, during discharge/power producing phase (denoted via a forward arrow, →), the Nernst potential must also include a term for CO₂ capture, i.e.,

$${\overleftarrow{V}}_{0} = {\vec{V}}_{0} + {V}_{0 , CC}$$

where V_{0,CC} is the thermodynamic potentials pertaining to carbon capture, which, e.g., for the case of producing a pure CO₂ stream from a feed stream with CO₂ of mole fraction, x_{CO}_{₂}_{,f}

$${V}_{0 , CC} = ( \frac{R T}{{n}_{CC} F} ) ln ( \frac{{p}_{C {O}_{2} , p}}{{p}_{C {O}_{2} , f}} ) = ( \frac{R T}{{n}_{CC} F} ) ln ( \frac{1}{{x}_{{CO}_{2} , f}} )$$

where n_{CC} is the number of electrons transferred per molecule of CO₂ captured. Thus, n_{CC}=1, for HCO₃⁻, and n_{CC}=2, for CO₃²⁻. If both reactions occur to an appreciable degree, we may assume, n_{CC}≈1.5. The corresponding thermodynamic minimum work of separation,

$${W}_{CC , min} = \frac{{V}_{0 , CC} ( {n}_{CC} ) F}{M {W}_{C {O}_{2}}}$$

which is independent of n_{CC}. As an example, the minimum work of enriching CO₂ from the ambient environment (400 ppm CO₂), at 25° C.

$${W}_{CC , min} = \frac{R T}{M {W}_{C {O}_{2}}} ln ( \frac{1}{{x}_{{CO}_{2} , a}} ) = 8.314 \times 298 ln ( \frac{1}{0.0004} ) = 0.44 G J {t}^{- 1} {CO}_{2}$$

Further, the CO₂ flux to the NL

$${N}_{C {O}_{2}} = \frac{\overleftarrow{l}}{{n}_{C C} F}$$

The actual cell voltage for a cell in either the charge or the discharge mode is

$$V = {V}_{0} + \frac{R T}{{α}_{+} F} {sinh}^{- 1} [ \frac{1}{2} \{ \frac{i / ( {ε}_{+} {i}_{+ , 0} )}{1 - \vert i / ( {ε}_{+} {i}_{+ , L} ) \vert} \} ] + \frac{R T}{α\_F} {sinh}^{- 1} [ \frac{1}{2} \{ \frac{i / ( ε\_i {\_}_{, 0} )}{1 - \vert i / ( ε\_i {\_}_{, L} ) \vert} \} ] + i ( \frac{{L}_{IEM 1}}{{σ}_{IEM 1}} + \frac{{L}_{NL}}{{σ}_{NL}} + \frac{{L}_{IEM 2}}{{σ}_{IEM 2}} ) + i ( {R}_{I} )$$

which applies to both charge phase (when V= [symbol] and i>0, as per the sign convention for the external current density i) and discharge phase (when V=\vec{V} and i<0) modes. In the latter mode, thus, all the overpotential terms become subtracted from \vec{V}₀, as i<0, although the polarization relation remains unchanged. As a result, the actual cell voltage during discharge \vec{V}≤\vec{V}₀. On the other hand, [symbol] ≥ [symbol] ₀ during charge.

In the above polarization expression, V₀ is the Nernst cell potential that is a function of soc and pH as discussed above, the second and third terms on the right represent kinetic and mass transfer overpotentials of the positive and negative electrodes, η₊ and η₋, respectively, i_{+,0} and i_{-,0} are the corresponding exchange current densities, i_{+,L} and i_{-,L} are the limiting current densities reflecting pore-level mass transfer limitations to the internal electrode surface, and εr is the effectiveness factor reflecting ion transport limitations across the porous electrode thickness. The second-to-last term on the right includes the Ohmic potential drops in the IEM1-NL-IEM2 sandwich, where σ is the ionic conductivity and L is the layer/membrane thickness. Finally, R₁ accounts for any electronic and interfacial contact resistance.

Next, the area-specific resistance (ASR) of the cell is defined by

$$A S R ≡ \frac{V - {V}_{0}}{i} ( Ω {cm}^{2} )$$

In addition, the power density, P≡(i)V (W cm⁻²). Like the polarization expression, these equations apply to both charge/carbon capture mode, e.g., [symbol] =i [symbol] = [symbol] ( [symbol] ), and discharge mode), i.e., \vec{P}=i\vec{V}=−\vec{ι}(\vec{V}). Here, \vec{ι}= [symbol] and \vec{ι}= [symbol] are both defined as >0. The power density in a RFB with a pH differential is higher since the cell voltage is higher. On the other hand, the cycle efficiency can be lower if the overpotential losses in the additional layers are not fully compensated by the higher potential

An average battery energy efficiency may be defined for energy storage over a charge-discharge cycle, assuming that the conditions don't vary significantly over most of the cycle as the soc varies

$${\overleftrightarrow{ε}}_{E S} ≡ \frac{\int ( - \vec{P} ) d t}{\int ( \overleftarrow{P} ) dt} = \frac{\int ( \vec{V} ) \vec{ι} d t}{\int ( \overleftarrow{V} ) \overleftarrow{ι} dt} \approx \frac{\vec{ι} ( \vec{V} )}{\overleftarrow{ι} ( \overleftarrow{V} )} \approx \frac{\vec{V}}{\overleftarrow{V}}$$

where in the last expression it is assumed that \vec{ι}= [symbol] , i.e., the current density during charge and discharge is the same.

If the work expenditure attributable to carbon capture is that due to thermodynamic work of carbon capture, V_{0,CC}, plus twice (once during charge and again during discharge) the difference in overpotentials in a cell with nonuniform pH and that in a cell with uniform pH. Ignoring any kinetics differences, this is mainly due to the Ohmic resistances in the second membrane and the neutralyte layer, then, the energy efficiency of CC

$${ϵ}_{e C C} = \frac{{V}_{0 , CC} / {n}_{C C}}{{V}_{0 , CC} + 2 \overleftarrow{ι} ( \frac{{L}_{CEM 1}}{{σ}_{CEM 1}} + \frac{{L}_{NL}}{{σ}_{NL}} )}$$

The above theoretical model provides guidance in terms of designing a system with high efficiency and low cost: 1) the efficiency being governed largely by the operating voltage; 2) while the cost is in large part determined by the choice of the redox system chosen for efficient electron transfer reaction, i.e., one that does not require use of expensive catalysts, along with a high operating current density.

The following guidelines are useful:
If the goal is simply carbon capture, then the cell voltage should be minimized to improve carbon capture efficiency. Thus, one should choose a redox system with a minimum V₀^{o}. In fact, if the same redox system is chosen for both the posolyte and the negolyte, the standard cell voltage V₀^{o}=0. The chosen redox couple should be stable at the two different pHs at the two electrodes.
On the other hand, when energy storage is also a goal, the redox couples should be chosen so that V₀^{o} is maximized.
Lowering V_{ΔpH} by using a lower pH differential is useful for carbon capture alone, but not for energy storage.
Reducing the electrode overpotentials at the two electrodes, η₊ and η₋. This would require redox couples with large exchange current densities. However, since η₊ and η₋ involve both kinetic and diffusion overpotentials, high concentrations of the redox species as well as of CO₂ is also useful.
Low potential drops in the two ion-exchange membranes, η_{IEM1} and η_{IEM2}. Since CEMs, in general, have higher conductivities, use of two CEMs may be indicated rather than one or more AEMs. Further, lower thickness of the membranes is useful, but must be balanced with desire for a long life and robustness of the assembly.
Small overpotential in the intermediate layer, NL. This means that the thickness of the layer should be minimum, and concentration of any electrolyte should be high.

The cost of the unit may be reduced by:
Operating at higher current/power densities, so that stack area may be minimized
Selecting redox couples that are inexpensive with facile kinetics, so that there is little use for catalysts in the electrodes, and inexpensive graphite electrodes suffice.

Higher overall efficiency results when carbon capture is combined with energy storage function in the same cell. This has not so far been accomplished in the literature.

### Component Selection

Based on the preceding discussion of the basic principles and general features of the proposed electrochemical carbon capture combined energy storage cell, it is clear that there is a large variety of options available for cell design, materials for the membranes and neutralyte layer, electrodes, and the composition of the posolyte (acidic), and the negolyte (alkaline) as further elaborated below.

The desired ion-exchange membranes (IEMs) used in the cell are selective ion conducting and electrically insulating membranes that also discourage cross-diffusion of other ionic and molecular species. The IEMs generally constitute a neutral polymer backbone bonded to repeating pendant ionomer units. The ion-exchange membranes in the present disclosure may be anion- or cation-exchange, conducting membranes, or both.

For cation-exchange membranes (CEMs), the pendant ionomer units include anionic functional groups including carboxylates, sulfonates, phosphonates, and the like. The strength of the pendant ionomer units, e.g., —(COO⁻)H⁺ versus —(SO₃⁻)H⁺, is used to accomplish a desired pH in the membrane. For anion-exchange membranes (AEMs), these polymer compositions may include attached or embedded quaternary ammonium, imidazolium, sulfonium, phosphonium, phosphazenium, and guanidinium groups, or salts.

In CEMs, the pendant ionomer groups are charge-balanced by exchangeable cations such as mono-, di-, or higher-valent cations A⁺, such as protons, H⁺, and alkaline earth metals, such as Li⁺, Na⁺, K⁺, Mg²⁺, and Ca²⁺. In AEMs, the pendant groups are charge-balanced by exchangeable anions such as mono-valent anions such as hydroxyl ions OH⁻, halogen-based anions such as Cl⁻, Br⁻, and I⁻, bicarbonate ion HCO₃⁻, bisulfate ion HSO₃⁻, and di-valent, or higher-valent anions such as the carbonate ion CO₃²⁻, and sulfate ion SO₄²⁻, etc.

An example of a membrane with fluorinated or perfluorinated polymer backbone is Nafion® manufactured by E. I. du Pont de Nemours and Company, Wilmington, Delaware. Non-fluorinated membranes include those with substantially aromatic backbones, e.g., polystyrene, polyphenylene, bi-phenyl sulfone (BPSH), or thermoplastics such as polyetherketones or polyethersulfones, and the like. Commercial manufacturers of AEMs include Fumatech (Germany), Solvay (Belgium), Tokuyama (Japan), Ionics (USA), Dioxide Materials (USA), and Asahi Glass (Japan).

In addition to active redox species, supporting electrolytes of different pH are used at either electrode to facilitate carbon dioxide capture and release, a desired cell potential, and charge transfer within the electrode for energy storage. Any supporting electrolyte, in combination with any redox species, used at the positive electrode is called posolyte, while such a solution used at the negative electrode is called negolyte.

The supporting electrolytes comprise of an aqueous or nonaqueous solvent along with salts, acids, or bases to aid in ionic conductivity, as well as to provide the counterions for the redox species. The supporting electrolyte in itself is generally redox inactive in the window of electric potentials of interest. Examples include salts of an alkali metal, ammonium ion including an animonium ion partially or wholly substituted by alkyl or aryl groups, halide, chalcogenide, phosphate, hydrogen phosphate, phosphonate, nitrate, sulfate, nitrite, sulfite, perchlorate, tetrafluoroborate, hexafluorophosphate, or a mixture thereof, and the like. In some embodiments, the pH of the electrolyte may be maintained using a buffer. Typical buffers include salts of phosphate, borate, carbonate, silicate, trisaminomethane (Tris), 4-(2-hydroxyethyl)-1-pipera-zincethanesulfonic acid (HEPES), piperazine-N,N′-bis(ethanesulfonic acid) (PIPES), and combinations thereof. These may be supplemented with an acid (e.g., HCl, HNO₃, H₂SO₄), or a base (e.g., NaOH, KOH, NH₄OH), and the like, for attaining a desired pH in a given electrolyte.

The intermediate neutralyte layer (NL) is similar to the separator layer in conventional batteries, and is comprised of a porous inert polymer or a ceramic membrane. Suitable polymers, for instance, include those chemically compatible with the supporting electrolytes of the presently described system, including high density polyethylene, polypropylene, polyvinylidene difluoride (PVDF), or poly-tetrafluoroethylene (PTFE). Porous ceramic membranes are chemically compatible oxides, nitrides, or carbides of various metals, e.g., Al₂O₃, SiO₂, ZrO₂, TiO₂, NiO, SiC, etc.

The negative and the positive electrodes are typically porous carbon felt or paper electrodes to provide large surface area, decorated, when needed, with catalytic materials so as to facilitate the redox reactions at either electrode. However, numerous other porous inert metal felts, e.g., Ti or Ni foam, can also be suitable materials for the negative and the positive electrodes/catalysts that can facilitate the desired electron transfer reactions by providing a large interfacial area as well as facile kinetics of electron transfer to and from the interface.

The Nernst cell equilibrium voltage V₀, a key determinant of cell energy storage efficiency, is determined by the difference in the Nernst electrode potentials of the posolyte and the negolyte redox couples. The careful selection of the redox couples determines the equilibrium cell voltage but also, reaction kinetics, number of electrons n involved in the electrode reactions, the chemical and oxygen stability of the electrolytes, cost, potential for water electrolysis, and their environmental benignity. There are, in fact, numerous possible choices, and their selection for a given application must be made carefully.

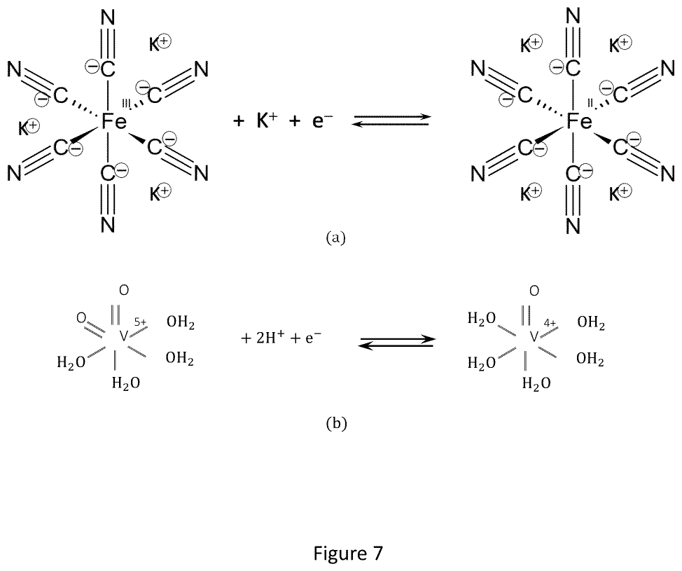

The posolyte redox molecule candidates should be soluble and stable in acidic electrolytes, and many potential choices are listed in Table I, while many negolyte candidates that are relatively soluble and stable in alkaline electrolytes are listed in Table II. Further, although organic redox molecules such as quinones have been widely investigated, including as sorbents for CO₂, transition metal-based compounds, which constitute the bulk of redox active materials, as listed in Tables 1 and 2, have not so far been utilized for this purpose, as proposed herein. FIGS. 7a and 7b show two different examples of such redox species in alkaline (FIG. 7a) and acidic (FIG. 7b) media.

The transition metal compounds such as those in FIG. 7, and listed in Tables 1 and 2, contain at their coordination center a multi-valent transition metal ion that can undergo a change in its oxidation state, M⁽ⁿ⁺¹⁾⁺/Mⁿ⁺, e.g., Fe^{3+/2+}, or Co^{3+/2+}, surrounded by ligands, L, bound to it via lone pairs of electrons, along with counterions and exchangeable ions as cations A⁺, e.g., H⁺, or K⁺, or anions B⁻, e.g., OH⁻, Cl⁻, HSO₄⁻, etc., to balance the change in the metal center oxidation state, as shown in FIG. 7. Polydentate ligands are especially useful for entropic stabilization of the chelate effect and avoiding the formation of transition metal hydroxides and hydrous oxides and leading to precipitation from basic electrolytes.

Many of the metal-ligand complexes, or coordination complexes, possess well-known molecular geometry, e.g., tetrahedral structure for a metal, e.g., Zn, with coordination number 4, and octahedral structure for a metal, e.g., V, with a coordination number 6. Thus, a central metal M is typically linked symmetrically to four or six ligands.

As an example, the V^{5+/4+} complexes shown in FIG. 7(b) are octahedral aqua complexes of V bound to ligand H₂O via O, along with H⁺ as the exchangeable ions. On the other hand, FIG. 7a shows the Fe^{3+/2+} coordination center with the bulkier cyanate ligands, and exchangeable K⁺ ions. The advantage of bulkier ligands is that it reduces the chance of cross-over of the active material across the membrane. The tetrahedral and octahedral cation structures together, in fact, form the Keggin structures in polyoxymetalates (POMs), including heteropolyacids (HPAs), which can be used as redox active materials in the cells described herein.

There are innumerable possibilities of the various transition metals with multiple oxidation states, which include Co, Cr, Sr, Cu, Fe, Mg, Mn, Mo, Ni, Pd, Pt, Ru, Sn, Ta, Ti, Zn, Zr, Nb, Mo, V, or a combination thereof. Many examples are included in Table I and Table II in acidic and basic aqueous solutions. Some of the compounds of interest are stable in both acidic and basic media, and provide the opportunity to use the same redox species in both the posolyte and in the negolyte. This is of particular interest when carbon capture is the main goal, as then the Nernst cell voltage reduces to reflect mainly the difference in pH and in the ionic strength of the electrolytes.

TABLE I
Standard Redox potentials in acid solutions (pH = 0) for
typical electrode reactions.

| | | | Φ_{0,298}^{o} |
|---|---|---|---|
| | | | (V vs. |
| Electrode | Electrode Reaction | n | SHE) |
| F⁻/F₂ | 2F⁻ [symbol] F₂ + 2e⁻ | 2 | +2.866 |
| Cu²⁺/Cu³⁺ | Cu²⁺ [symbol] Cu³⁺ + e⁻ | 1 | +2.4 |
| Co²⁺/Co³⁺ | Co²⁺ [symbol] Co³⁺ + e⁻ | 1 | +1.82 |
| Ag⁺/Ag²⁺ | Ag⁺ [symbol] Ag²⁺ + e⁻ | 1 | +1.8 |
| Ce³⁺/Ce⁴⁺ | Ce³⁺ [symbol] Ce⁴⁺ + e⁻ | 1 | +1.72 |
| PbSO₄/PbO₂ | PbSO₄ + 2H₂O [symbol] PbO₂ + SO₄²⁻ + 4H⁺ + 2e⁻ | 2 | +1.6913 |
| Ce²⁺/Ce³⁺ | Ce²⁺ [symbol] Ce³⁺ + e⁻ | 1 | +1.67 |
| Mn²⁺/Mn³⁺ | Mn²⁺ [symbol] Mn³⁺ + e⁻ | 1 | +1.5415 |
| Mn²⁺/MnO₄⁻ | Mn²⁺ 4H₂O [symbol] MnO₄⁻ + 8H⁺ + 5e⁻ | 5 | +1.507 |
| Pb²⁺/PbO₂ | Pb²⁺ + 2H₂O [symbol] PbO₂ + 4H⁺ + 2e⁻ | 2 | +1.455 |
| Cl⁻/Cl₂ | 2Cl⁻ [symbol] Cl₂ + 2e⁻ | 2 | +1.3583 |
| Cr³⁺/Cr₂O₇²⁻ | 2Cr³⁺ + 7H₂O [symbol] Cr₂O₇²⁻ + 4H⁺ + 6e⁻ | 6 | +1.36 |
| Cr⁴⁺/Cr⁵⁺ | Cr⁴⁺ [symbol] Cr⁵⁺ + e⁻ | 1 | +1.34 |
| Tl⁺/Tl³⁺ | Tl⁺ [symbol] Tl³⁺ + 2e⁻ | 2 | +1.252 |
| O₂/H₂O | 2H₂O [symbol] O₂ + 4H⁺ + 4e⁻ | 4 | +1.229 |
| Br⁻/Br₂ | 2Br⁻ [symbol] Br₂ + 2e⁻ | 2 | +1.0873 |
| TeO₂/H₆TeO₆ | TeO₂ + 4H₂O [symbol] H₆TeO₆ + 2H⁺ + 2e⁻ | 2 | +1.02 |
| VO²⁺/VO₂⁺ | VO²⁺ + H₂O [symbol] VO₂⁺ + 2H⁺ + e⁻ | 1 | +1.004 |
| Ru(CN)₆⁴⁻/ | Ru(CN)₆⁴⁻ [symbol] Ru(CN)₆³⁻ + e⁻ | 1 | +0.86 |
| Ru(CN)₆³⁻ | | | |
| Fe(bipy)₂²⁺/ | Fe(bipy)₂²⁺ [symbol] Fe(bipy)₂³⁺ + e⁻ | 1 | +0.78 |
| Fe(bipy)₂³⁺ | | | |
| Fe²⁺/Fe³⁺ | Fe²⁺ [symbol] Fe³⁺ + e⁻ | 1 | +0.771 |
| H₂Q/Q | H₂Q [symbol] Q + 2H⁺ + 2e⁻ | | +0.6992 |
| O₂/H₂O₂ | H₂O₂ [symbol] O₂ + 2H⁺ + 2e⁻ | 2 | +0.682 |
| I⁻/I₂ | 2I⁻ [symbol] I₂ + 2e⁻ | 2 | +0.536 |
| Ferrocene/ | Ferrocene [symbol] Ferrocinium⁺ + e⁻ | 1 | +0.400 |
| Ferrocinium⁺ | | | |
| Fe(CN₆⁴⁻/ | Fe(CN)₆⁴⁻ [symbol] Fe(CN)₆³⁻ + e⁻ | 1 | +0.358 |
| Fe(CN)₆³⁻ | | | |
| Hg/Hg₂Cl₂ | 2Hg + 2Cl⁻ [symbol] Hg₂Cl₂ + 2e⁻ | 2 | +0.2681 |
| Calomel Electrode | Calomel Electrode, Saturated KCl | | +0.2412 |
| Ag/AgCl | Ag + Cl⁻ [symbol] AgCl + e⁻ | 1 | +0.2223 |
| Ag₄Fe(CN)₆/ | 4Ag + Fe(CN)₆⁴⁻ [symbol] Ag₄Fe(CN)₆ +4e⁻ | 4 | +0.1478 |
| Fe(CN)₆³⁻ | | | |
| Ru(NH₃)₆²⁺/ | Ru(NH₃)₆²⁺ [symbol] Ru(NH₃)₆³⁺ + e⁻ | 1 | +0.10 |
| Ru(NH₃)₆³⁺ | | | |
| Ag/AgBr | Ag + Br⁻ [symbol] AgBr +e⁻ | 1 | +0.0713 |
| H₂/H⁺ | H₂ [symbol] 2H⁺ + 2e⁻ | 2 | 0.0000 |
| Ti³⁺/Ti(OH)³⁺ | Ti³⁺ + H₂O [symbol] Ti(OH)³⁺ + H⁺ + e⁻ | 1 | −0.055 |
| Pb/Pb²⁺ | Pb [symbol] Pb²⁺ + 2e⁻ | 2 | −0.1262 |
| In/In⁺ | In [symbol] In⁺ + e⁻ | 1 | −0.14 |
| Ag/AgI | Ag + I⁻ [symbol] AgI + e⁻ | 1 | −0.1522 |
| HCOOH | HCOOH [symbol] CO₂ + 2H⁺ + 2e⁻ | 2 | − 0.199 |
| Ga/Ga⁺ | Ga [symbol] Ga⁺ + e⁻ | 1 | −0.2 |
| V²⁺/V³⁺ | V²⁺ [symbol] V³⁺ + e⁻ | 1 | −0.26 |
| In/In³⁺ | In [symbol] In³⁺ + 3e⁻ | 3 | −0.3382 |
| PbSO₄/PbO₂ | Pb + SO₄²⁻ [symbol] PbSO₄ + 2e⁻ | 2 | −0.3588 |
| Cr²⁺/Cr³⁺ | Cr²⁺ [symbol] Cr³⁺ + e⁻ | 1 | −0.407 |
| Fe/Fe²⁺ | Fe [symbol] Fe²⁺ + 2e⁻ | 2 | −0.447 |
| Ti²⁺/TiO₂ | Ti²⁺ + 2H₂O [symbol] TiO₂ + 4H⁺ + 2e⁻ | 2 | −0.502 |
| Ga/Ga³⁺ | Ga [symbol] Ga³⁺ + 3e⁻ | 3 | −0.549 |
| Zn/Zn²⁺ | Zn [symbol] Zn²⁺ + 2e⁻ | 2 | −0.7618 |
| H₂Te/Te | H₂Te [symbol] Te + 2H⁺ + 2e⁻ | 2 | −0.793 |
| Ti²⁺/Ti³⁺ | Ti²⁺ [symbol] Ti³⁺ + e⁻ | 1 | −0.9 |
| Ti/Ti³⁺ | Ti [symbol] Ti³⁺ + 3e⁻ | 3 | −1.37 |
| Al/Al³⁺ | Al [symbol] Al³⁺ + 3e⁻ | 3 | −1.662 |
| Na/Na⁺ | Na [symbol] Na⁺ + e⁻ | 1 | −2.71 |
| K/K⁺ | K [symbol] K⁺ + e⁻ | 1 | −2.931 |
| Li/Li⁺ | Li [symbol] Li⁺ + e⁻ | 1 | −3.0401 |

TABLE II
Standard Redox potentials in basic solutions (pH = 14) for typical
electrode reactions

| | | | Φ_{0, 298}^{o} |
|---|---|---|---|
| | | | (V vs. |
| Electrode | Electrode Reaction | n | SHE) |
| FeO₂⁻/FeO₄²⁻ | FeO₂⁻ + 4OH⁻ [symbol] FeO₄²⁻ + 2H₂O + 3e⁻ | 3 | +0.9 |
| AgO/Ag₂O₃ | 2AgO + 2OH⁻ [symbol] Ag₂O₃ + H₂O + 2e⁻ | 2 | +0.739 |
| Ag₂O/AgO | Ag₂O + 2OH⁻ [symbol] 2AgO + H₂O + 2e⁻ | 2 | +0.607 |
| MnO₂/MnO₄⁻ | MnO₂ + 4OH⁻ [symbol] MnO₄⁻ + 2H₂O + 2e⁻ | 2 | +0.60 |
| Ni(OH)₂/Ni(OOH) | Ni(OH)₂ + OH⁻ [symbol] Ni(OOH) + H₂O + e⁻ | 1 | +0.49 |
| Fe(CN)₆⁴⁻/Fe(CN)₆³⁻ | Fe(CN)₆⁴⁻ [symbol] Fe(CN)₆³⁻ + e⁻ | 1 | +0.49 |
| 4OH⁻/O₂ | 4OH⁻ [symbol] O₂ + 2H₂O + 4e⁻ | 4 | +0.401 |
| Ag/Ag₂O | 2Ag + 2OH⁻ [symbol] Ag₂O + H₂O + 2e⁻ | 2 | +0.344 |
| PbO/PbO₂ | PbO + 2OH⁻ [symbol] PbO₂ + H₂O + 2e⁻ | 2 | +0.248 |
| Co(OH)₂/Co(OH)₃ | Co(OH)₂ + OH⁻ [symbol] Co(OH)₃ + e⁻ | 1 | +0.17 |
| Pt/Pt(OH)₂ | Pt + 2OH⁻ [symbol] Pt(OH)₂ + 2e⁻ | 2 | +0.14 |
| Mn(OH)₂/Mn(OH)₃ | Mn(OH)₂ + OH⁻ [symbol] Mn(OH)₃ + e⁻ | 1 | +0.15 |
| Co(NH₃)₆²⁺/Co(NH₃)₆³⁺ | Co(NH₃)₆²⁺ [symbol] Co(NH₃)₆³⁺ + e⁻ | 1 | +0.108 |
| NH₃OH/N₂H₄ | 2NH₃OH + 2OH⁻ [symbol] N₂H₄ + 4H₂O + 2e⁻ | 2 | +0.1 |
| Mn(OH)₂/MnO₂ | Mn(OH)₂ + 2OH⁻ [symbol] MnO₂ + H₂O + 2e⁻ | 2 | −0.05 |
| Tl(OH)/Tl(OH)₃ | Tl(OH) + 2OH⁻ [symbol] Tl(OH)₃ + 2e⁻ | 2 | −0.05 |
| Cu₂O/Cu(OH)₂ | Cu₂O + 2OH⁻ + H₂O [symbol] 2Cu(OH)₂ + 2e⁻ | 2 | −0.08 |
| Cr(OH)₃/CrO₄²⁻ | Cr(OH)₃ + 5OH⁻ [symbol] CO₄²⁻ + 4H₂O + 3e⁻ | 3 | −0.13 |
| Tl/TlOH | Tl + OH⁻ [symbol] TlOH + e⁻ | 1 | −0.34 |
| Cu/Cu₂O | 2Cu + 2OH⁻ [symbol] Cu₂O + H₂O + 2e⁻ | 2 | −0.360 |
| Bi/Bi₂O₃ | 2Bi + 6OH⁻ [symbol] Bi₂O₃ + 3H₂O + 6e⁻ | 6 | −0.46 |
| Ni(OH)₂/NiO₂ | Ni(OH)₂ + 2OH⁻ [symbol] NiO₂ + 2H₂O + 2e⁻ | 2 | −0.49 |
| Fe(OH)₂/Fe(OH)₃ | Fe(OH)₂ + OH⁻ [symbol] Fe(OH)₃ + e⁻ | 1 | −0.56 |
| Cd/Cd(OH)₄²⁻ | Cd + 4OH⁻ [symbol] Cd(OH)₄²⁻ + 2e⁻ | 2 | −0.658 |
| Ni/Ni(OH)₂ | Ni + 2OH [symbol] Ni(OH)₂ + 2e⁻ | 2 | −0.72 |
| Co/Co(OH)₂ | Co + 2OH⁻ [symbol] Co(OH)₂ + 2e⁻ | 2 | −0.73 |
| Cd/Cd(OH)₂ | Cd + 2OH⁻ [symbol] Cd(OH)₂ + 2e⁻ | 2 | −0.81 |
| H₂/H₂O | H₂ + 2OH⁻2 [symbol] H₂O + 2e⁻ | 2 | −0.822 |
| In/In(OH)₄⁻ | In + 4OH⁻ [symbol] In(OH)₄⁻ + 3e⁻ | 3 | −1.099 |
| Zn/Zn(OH)₄²⁻ | Zn + 4OH⁻ [symbol] Zn(OH)₄²⁻ + 2e⁻ | 2 | −1.199 |
| Ga/H₂GaO₃⁻ | Ga + 4OH⁻ [symbol] H₂GaO₃⁻ + H₂O + 3e⁻ | 3 | −1.219 |
| Al/Al(OH)₃ | Al + 3OH⁻ [symbol] Al(OH)₃ + 3e⁻ | 3 | −2.31 |
| Mg/Mg(OH)₂ | Mg + 2OH⁻ [symbol] Mg(OH)₂ + 2e⁻ | 2 | −2.690 |

While Tables 1 and 2 list many possible redox couple combinations, it is obvious that there are many other possibilities, including organic, inorganic, and organometallic species. It is to be further noted that for the values reported in Table II at the high pH, the effect of pH is already included.

Examples of various cell configurations along with some redox couples are provided below. While, as indicated below, some of the following exemplary cell configurations have been used before for the purpose of energy storage, none have been used for the purpose of carbon capture alone or for the purpose of combined carbon capture and energy storage.

### Example System Configurations

Given the wide variety of component material choices, combined with the four different ⊖-IEM1-NL-IEM2-⊕ arrangements, namely: a) ⊖-AEM-NL-CEM-⊕, b) ⊖-CEM-NL-AEM-⊕, c) ⊖-CEM1-NL-CEM2-⊕, and d) ⊖-AEM1-NL-AEM2-⊕, a very large number of implementation schemes are possible. Further, there are the following four different ions potentially available for charge transfer, namely, the two cations, H⁺ (posolyte) and A⁺ (negolyte), and the two anions, OH⁻ and X⁻ (posolyte), the ions A⁺ (negolyte) and X⁻ (posolyte) resulting from the supporting electrolytes. In addition, when carbon capture is involved in alkaline electrolytes, there are two additional anions, HCO₃⁻ and CO₃⁻, in the negolyte.

For instance, ignoring the CO₂ bearing anions, for the case of a cell based on an AEM and a CEM arrangement, the following choices are possible for the charge transfer ions: 1) H⁺ and OH⁻; 2) H⁺ and X⁻; 3) A⁺ and OH⁻; and 4) A⁺ and X⁻. For the case of two CEMs or two AEMs as the ion-exchange membranes, the possible choices are: 5) X⁻ and OH⁻; and 6) H⁺ and A⁺. In other words, the choice of the membranes as well as that for the ions for charge transfer between the electrodes determines the chemistry at the electrodes and the arrangements for material flow. The choice of the redox couples and their concentrations at either electrode depend upon the goal, i.e., whether it is exclusively carbon capture or energy storage, or whether the goal is to couple carbon capture with energy storage.

The above-mentioned details need to be carefully considered from an efficiency and materials perspective in cell design for a given application. Only a few exemplary arrangements are described below. It should be evident that many other configurations may be apparent within the scope of the claimed approach.

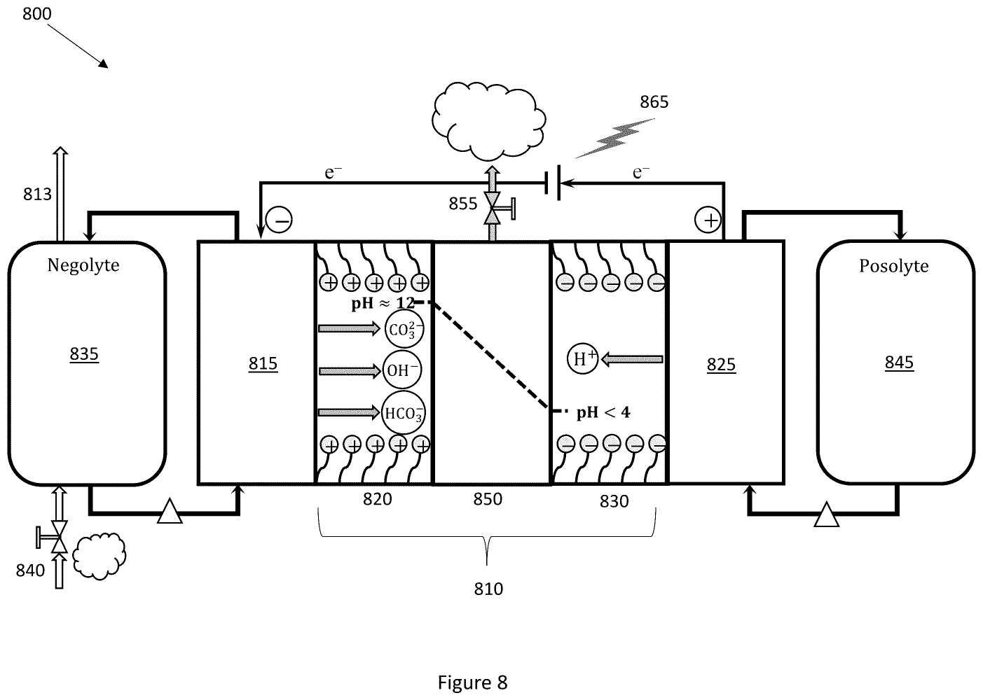

1) An ⊖-AEM-NL-CEM-⊕ arrangement: FIG. 8 provides a schematic of an exemplary system 800 with an AEM-NL-CEM membrane arrangement 810. The NL 850 is flanked by a negative electrode 815 adjacent to the AEM 820 and a positive electrode 825 in contact with the CEM 830 (separate chambers such as alkaline negolyte chamber 135 and acidic posolyte chamber 140 shown in FIG. 1 are not shown for simplicity).

A negolyte tank 835 is fed with CO₂ via inlet 840 from a CO₂ source such as flue gas or ambient air. Cleansed exhaust leaves the negolyte tank 835 via outlet 813. Acidic posolyte is contained in posolyte tank 845. Pure CO₂ exits the AEM-NL-CEM membrane arrangement 810 along exhaust 855. Load 865 is electrically connected to AEM-NL-CEM membrane arrangement 810.

The system 800 also includes CO₂ absorption in the alkaline negolyte, contained in tank 835. The absorption operates according to:

OH⁻+CO₂⇄HCO₃⁻

OH⁻+HCO₃⁻⇄CO₃²⁻+H₂O.

The system 800 in FIG. 8 features a generic R₋/O₋ couple at the negative electrode 815 (denoted by the subscript “−”) dissolved in an aqueous alkaline (A⁺OH⁻) supporting electrolyte called “negolyte,” and another R₊/O₊ couple at the positive electrode 825 (denoted by the subscript “+”) dissolved in an aqueous acidic (H⁺X⁻) supporting electrolyte called “posolyte.”

The CO₂ source is directly contacted with the negolyte at a high pH to capture the CO₂ as bicarbonate and carbonate ions, and the resulting solution is pumped to the negative electrode 815, while posolyte from posolyte tank 845 is pumped to the positive electrode 825.

At the negative electrode 815, in the carbon-capture/charging phase, the oxidant molecule in the negolyte is reduced while restoring alkalinity via concomitant generation of the hydroxyl ions, and the reductant in the posolyte is oxidized at the positive electrode, generating protons, and hence acidity, to sustain the pH differential across the NL 850, where CO₂ is released. For example, the pH in the negolyte can be around 12 while the pH in the posolyte can be less than 4.

The ρ^{th} reaction steps in layer l (labeled s_{l,ρ}) that occur in the different layers of the cell are also listed below for generic redox couples and choice of H⁺ and OH⁻ as the key (in addition to HCO₃⁻ and CO₃²⁻) charge transfer ions via the membranes:

| Component | | Reaction |
|---|---|---|
| Cathode, | s_{-, 1}: | O₋ + AOH +e⁻ [symbol] R₋ + OH⁻ |
| Contactor, | s_{C, 1}: | OH⁻ + CO₂ [symbol] HCO₃⁻ |
| NL, | s_{C, 2}: | OH⁻ + HCO₃⁻ [symbol] CO₃²⁻ + H₂O |
| | s_{NL, 1}: | H⁺ + CO₃²⁻ [symbol] HCO₃⁻ |
| | s_{NL, 2}: | H⁺ + HCO₃⁻ [symbol] H₂O + CO₂ |
| | s_{NL, 3}: | H⁺ + OH⁻ [symbol] H₂O |
| Anode, | s_{+, 1}: | R₊ [symbol] O₊ + H⁺ + e⁻ |

| | |
|---|---|
| Cell OR: | 0₋ + AOH + R₊ [symbol] R₋ + H₂O + O₊ |
| CO₂ Capture: | CO_{2, f} [symbol] CO_{2, p} |

Thus, the anions in the negolyte, namely, OH⁻, HCO₃⁻, and CO₃²⁻, migrate directly via the AEM 820 to arrive at the NL 850 (from the electrode compartment), while the protons formed at the positive electrode 825 migrate across the CEM 830 to arrive at the NL 850, where they combine with the anions as described in above reactions, releasing pure CO₂ along exhaust 855 that is suitable for storage or for further processing.

As an exemplary system, we consider R₋/O₋=[Fe^{II}(CN)₆]⁴⁻/[Fe^{III}(CN)₆]³⁻, the ferro-/ferri-cyanate couple, and R₊/O₊=QH₂/Q, the hydroquinone/quinone couple. Further, for the supporting electrolytes, we assume A⁺OH⁻=K⁺OH⁻ in the negolyte, and H⁺X⁻=H⁺Cl⁻ in the posolyte. Then, the electrode reaction steps are

$$Neg : {{K}_{3}^{+} [ {{Fe}^{I I I} ( CN )}_{6} ]}^{3 -} + {K}^{+} {OH}^{-} + {e}^{-} ⇄ {{K}_{4}^{+} [ {{Fe}^{I I} ( CN )}_{6} ]}^{4 -} + {OH}^{-} ; {( {Φ}_{- , 0}^{o} )}_{p H = 0} = + 0.3 \; 58 V$$

$$Pos : \qquad {H}_{2} Q ⇄ Q + 2 {H}^{+} + 2 {e}^{-} ; \qquad {( {Φ}_{+ , 0}^{o} )}_{p H = 0} = + 0.6 \; 992 V$$

The standard electrode potentials in the above are taken from Tables 1 and 2. It may be noted from these tables that the ferri/ferro-cyanate couple is feasible in both acidic and alkaline media, and consequently, the value of standard potential Φ_{-,0}^{o} above is taken at unit activity of protons (low pH), or highly acidic systems. The potential reported for the alkaline media in Table 2 already includes the effect of higher pH.

As a result, the overall cell reaction during the charging/carbon capture (reverse arrow, ←) phase for the above system is

$${H}_{2} Q + 2 {{K}_{3}^{+} [ {{Fe}^{I I I} ( CN )}_{6} ]}^{3 -} + 2 KOH ⇄ Q + 2 {{K}_{4}^{+} [ {{Fe}^{I I} ( CN )}_{6} ]}^{4 -} + 2 {H}_{2} O ; {( {V}_{0}^{o} )}_{p H = 0} = 0.3 \; 412 V$$

The overall cell Nernst potential, with the mass action term in terms of the state-of-charge (soc) of the electrolytes,

$$\overleftarrow{{V}_{0}} = {( {V}_{0}^{o} )}_{p H = 0} + \frac{R T}{n F} {ln ( \frac{s o c}{1 - s o c} )}^{2} + ( \frac{R T}{{n}_{C C} F} ) ln ( \frac{{p}_{C {O}_{2} , p}}{{p}_{C {O}_{2} , f}} ) + 2.3026 ( \frac{R T}{F} ) ( pH\_ - 2 p {H}_{+} )$$

i.e., besides the standard cell potential of the chosen couples, (V₀^{o})_{pH=0}, it is also strongly affected by the state-of-charge of the electrolytes, the desired CO₂ purification (here p_{CO}_{₂}_{,-} is the partial pressure of CO₂ in the source and p_{CO}_{₂}_{,+} is that in the captured stream), and the pH differential.

As an example, for this system for soc=0.5, capture of pure CO₂ (p_{CO}_{₂}_{,p}=1 atm.) directly from air (p_{CO}_{₂}_{,f}=0.00041 atm.), the Nernst potential of the cell, and pH₋=12 and pH₊=1, and n_{CC}=1.47.

$$\overleftarrow{{V}_{0}} = 0.3412 + ( \frac{8.314 \times 298}{2 \times 96 , 485} ) {ln ( \frac{0.5}{0.5} )}^{2} + ( \frac{8.314 \times 298}{1.47 \times 96 , 485} ) ln ( \frac{1}{0.00041} ) + 2.3 026 ( \frac{8.314 \times 298}{96 , 485} ) ( 12 - 2 \times 1 ) = 1. 7 V$$

Consequently, in the absence of any irreversibilities, or overpotentials, the theoretical maximum, or thermodynamic, efficiency of such a cell used exclusively for carbon capture, with [symbol] = [symbol] ₀

$${ϵ}_{C C , 0} = \frac{{V}_{0 , CC}}{\overleftarrow{{V}_{0}}} = \frac{0.1362}{1.07} = 1 2.7 \%$$

This efficiency can be improved further by: 1) selecting the redox couple to further reduce (V₀^{o})_{pH=0}; 2) minimizing the pH differential as necessary for CO₂ capture; and 3) operating at a low current density to minimize the overpotentials, although these are not accounted for in the above maximum theoretical efficiency.

One method of improving the carbon capture efficiency is to use a redox couple with a negative standard voltage, i.e., (V₀^{o})_{pH=0}<0. This might be illustrated simply by using the redox couples of the last example, but switching their polarity. In other words, if the ferro-/ferri-cyanate couple was used in the posolyte, i.e., R₊/O₊=[Fe^{II}(CN)₆]⁴⁻/[Fe^{III}(CN)₆]³⁻, and the hydroquinone/quinone couple in the negolyte, i.e., R₋/O₋=QH₂/Q, then (V₀^{o})_{pH=0}=(Φ_{+,0}^{o})_{pH=0}−(Φ_{-,0}^{o})_{pH=0}=+0.358−(+0.6992)=−0.3412. Then, from the preceding calculation,

$$\overleftarrow{{V}_{0}} = - 0.3412 + ( \frac{8.314 \times 298}{2 \times 96 , 485} ) {ln ( \frac{0.5}{0.5} )}^{2} + ( \frac{8.314 \times 298}{1.47 \times 96 , 485} ) ln ( \frac{1}{0.00041} ) + 2.3 026 ( \frac{8.314 \times 298}{96 , 485} ) ( 12 - 1 ) = 0.4 \; 454 V$$

Thus, the theoretical maximum, or thermodynamic, efficiency of the cell

$${ϵ}_{C C , 0} = \frac{{V}_{0 , CC}}{{\overleftarrow{V}}_{0}} = \frac{0.1362}{0.4454} = 3 0.6 \%$$

representing a dramatic improvement. It turns out that in the cited example, this is indeed feasible, since the hydroquinone/quinone couple is stable in alkaline conditions, and can be used, while the ferro/ferri-cyanate couple can also be employed under acidic conditions.

The cell Nernst potential is also affected by the soc. However, the soc changes with time for limited amounts of electrolyte. Once exhausted, the two redox couples at either electrode are either replenished chemically or regenerated electrochemically, e.g., by operating the cell cyclically in the reverse, when, depending upon whether the Nernst voltage is adequate to overcome the overpotentials, useful power is produced, which would further enhance the energy efficiency of the process. In fact, combined energy storage and carbon capture is the preferred manner of operation.

During such a discharge cycle (forward arrow, →) for the cell, since CO₂ is not involved, the reactions that occur are

| Component | | Reaction |
|---|---|---|
| Anode, | s_{-, 1}: | R₋ + OH⁻ [symbol] O₋ + AOH + e⁻ |
| NL, | S_{NL, 1}: | H₂O [symbol] H⁺ + OH⁻ |

| | |
|---|---|
| Cathode, | s_{+, 1}: O₊ + H⁺ + e⁻ [symbol] R₊ |
| Cell OR: | R₋ + H₂O + O₊ [symbol] O₋ + AOH + R₊ |

Thus, the Nernst cell potential reduces to

\vec{V}₀= [symbol] ₀−V_{0,CC}

Water ionization, during reverse bias occurs in the NL to supply protons to the positive electrode and hydroxyl ions to the negative electrode, in order to maintain the pH differential, i.e.,

H₂O⇄H⁺(aq)+OH⁻(aq)

The thermodynamic barrier for this reaction, ΔGᵣ^{o}=G_{H}_{⁺}_{(aq)}^{o}+G_{OH}_{^{−}}_{(aq)}^{o}−G_{f,H}_{₂}_{O(l)}^{o}=0+(−157.3)−(−237.2)=+79.9 kJ mol⁻¹=−RT ln K_{w}, is already included in the V_{ΔpH} term.

$${V}_{Δ p H} = 2.3026 ( \frac{R T}{F} ) ( {pH}_{-} - {pH}_{+} ) = \frac{Δ {G}_{r}^{o}}{n F} = 0.8 \; 28 V$$

However, additionally, there is significant kinetic overpotential for the water dissociation reaction. Thus, the water dissociation rate constant is small, \vec{k}_{w}=2.5×10⁻⁵ s⁻¹, along with an activation energy, \vec{E}_{w}=65-70 kJ mol⁻¹. This can be alleviated by incorporating a catalyst, or a salt, in the NL. For the forward bias, or for charging phase, the reaction in the NL 850 is the reverse, i.e., a combination of the protons and the hydroxyl ions, which is an instantaneous reaction, since, \vec{k}_{w}/\vec{k}_{w}=K_{w}≈1×10⁻¹⁴. Thus, the resulting polarization behavior because of the unidirectional flux in the current-voltage plot is akin to the rectifying behavior in a diode with a p-n junction, wherein the current is rectified until a breakdown voltage is reached. This irreversibility makes the ⊖-AEM-NL-CEM-⊕ arrangement described in FIG. 8 less efficient for combined carbon capture and energy storage. This issue also plagues bipolar membranes. More efficient arrangements are described below.

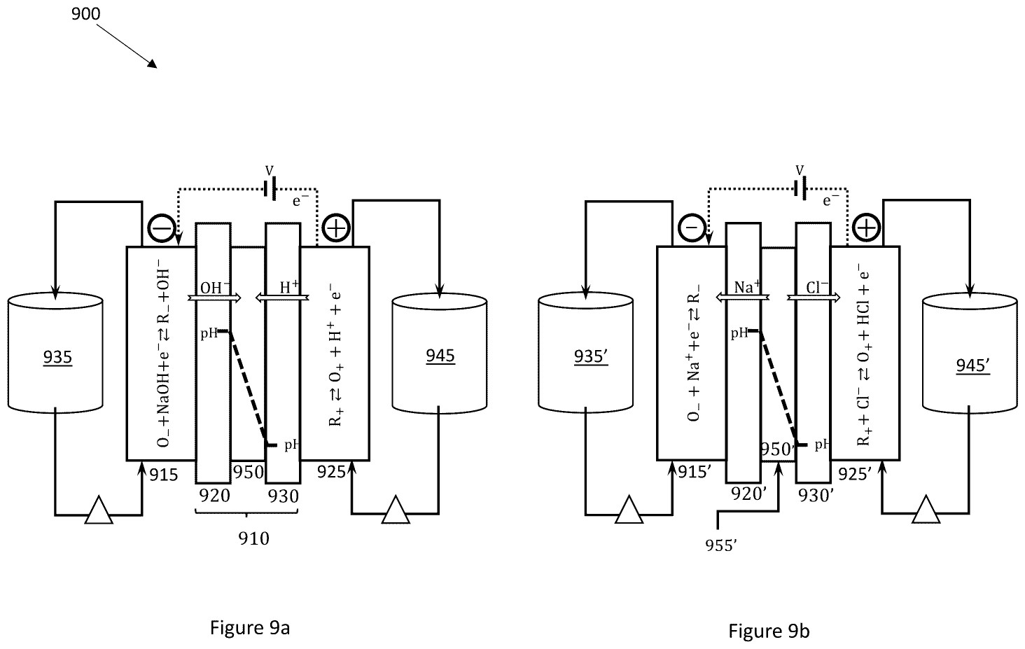

2) A ⊖-CEM-NL-AEM-⊕ arrangement: FIG. 9a shows a system 900 with a ⊖-AEM-NL-CEM-⊕ arrangement and FIG. 9b shows a system 900′ with a ⊖-CEM-NL-AEM-⊕ structure for a RFB in the charge mode. The reactions in the respective NL 950, 950′ are facile reactions.

In FIG. 9a, the NL 950 has a reaction that is H⁺+OH⁻⇄H₂O with the AEM 920 next to the negative electrode 915 and a CEM 930 next to the positive electrode 925. Accordingly, the configuration is an AEM-NL-CEM membrane arrangement 910.

The NL 950′ in FIG. 9b has a salt ionization reaction, e.g., NaCl⇄Na⁺+Cl⁻ with the CEM 920′ next to the negative electrode 915′ and an AEM 930′ next to the positive electrode 925′. NaCl electrolyte source 955′ is directed to the NL 950′

During the discharge phase the reactions are simply the reverse, e.g., water ionization H₂O⇄H⁺+OH⁻, and salt ion association, Na⁺+2Cl⁻⇄2NaCl. While the latter is still facile, the former is energetically forbidding.

One chemical system using these systems uses an alkaline [Zn(OH)₄]²⁻/Zn redox couple in a NaOH solution as the negolyte, and replaces the posolyte redox couple with a Fe²⁺/Fe³⁺ couple in an HCl solution, with a lower potential, Φ_{+,0}^{o}=+0.77 V to avoid oxygen evolution, with the resulting cell Nernst potential, V₀^{o}=Φ_{+,0}^{o}−Φ_{-,0}^{o}=+0.77−(−1.22)=1.99 V. The electrode reactions during discharge mode are

| Component | Reaction |
|---|---|
| −ve Electrode: | Zn + 4(Na⁺OH⁻) [symbol] Na₂⁺[Zn(OH)₄]²⁻ + 2Na⁺ + 2e⁻ |
| Neutralyte: | 2Na⁺ + 2Cl⁻ [symbol] 2NaCl |
| +ve Electrode: | 2H⁺[Fe³⁺Cl₄⁻] + 2(H⁺Cl⁻) + 2e⁻ [symbol] 2H₂⁺[Fe²⁺Cl₄⁻] + 2Cl⁻ |
| Cell: | Zn + 4(Na⁺OH⁻) +2H⁺[Fe³⁺Cl₄⁻] [symbol] Na₂⁺[Zn(OH)₄]²⁻ + 2H₂⁺[Fe²⁺Cl₄⁻] + |
| | 2NaCl |

This promising chemistry may be more successfully implemented in a cell design with two CEMs, as proposed next, more so when combined with carbon capture.

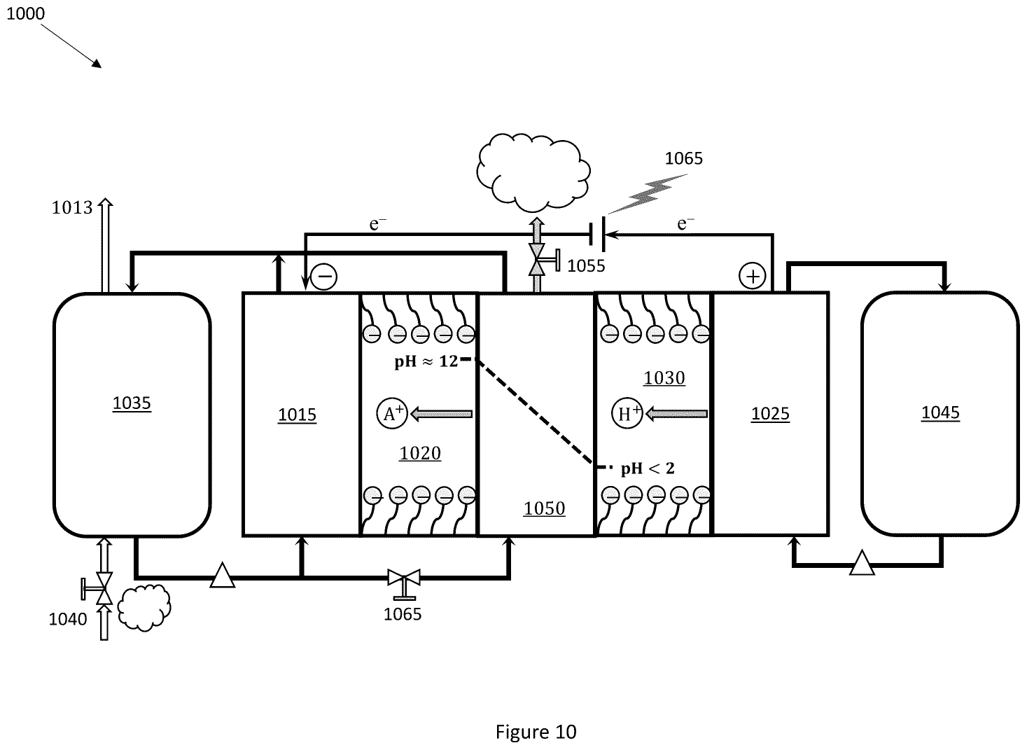

3) A ⊖-CEM1-NL-CEM2-⊕ arrangement: Another example that is especially attractive for carbon capture coupled with energy storage is the system 1000 shown in FIG. 10.

A negolyte tank 1035 is fed with CO₂ via inlet 1040 from a CO₂ source such as flue gas or ambient air. Cleansed exhaust leaves the negolyte tank 1035 via outlet 1013. Acidic posolyte is contained in posolyte tank 1045. Pure CO₂ exits the NL 1050 along exhaust 1055. Load 1065 is electrically connected to the AEM-NL-CEM membrane arrangement 1010.

This system 1000 differs from the examples above in that both the ion-exchange membranes are CEMs, so that the charge transfer ions are the alkali metal cation A⁺ in CEM1 1020 and the proton H⁺ in CEM2 1030. Such a schematic structure has not been proposed before for the purpose of either energy storage or in combination with carbon capture.

It can be especially advantageous to use both membranes as CEMs, since AEMs are not yet as well developed technologically or commercially, and possess considerably lower conductivity. Further, there are issues with mechanical and chemical robustness. They are also not able to effectively preclude the leakage of counterions (Na⁺/H⁺) through them. Another attractive feature of the twin-CEM scheme shown in FIG. 10 is that for energy storage the energetically demanding water dissociation reaction is not involved in the NL 1050.

Because of the absence of an AEM next to the negative electrode 1015, the OH-ion that restores alkalinity in the negolyte, as well as the HCO₃⁻ and CO₃²⁻ ions formed in the CO₂-negolyte contactor, cannot make their way to the NL 1050 directly via migration through the membrane (the CEM1 1020). As a result, a part of the negolyte (from negolyte tank 1035) must be pumped into the NL 1050, e.g., via pumping mechanism 1065 as well as to be in communication with the negative electrode 1015. The cations A⁺ also accompany the bicarbonate, carbonate, and hydroxyl anions to the NL 1050, along with the redox (R₋/O₋) species. The cations A⁺ are, however, returned from the NL 1050 to the negative electrode 1015 via ionic migration through the CEM1 1020. The protons formed in the reaction at the positive electrode 1025 and streaming into the NL 1050 via CEM2 1030 reduce the negolyte pH there, resulting in the evolution of CO₂. The acidified negolyte issuing from the NL 1050 is mixed with the negolyte exiting from the negative electrode 1015, where its alkalinity has been restored via formation of the hydroxyl ions, and the mixture is thereupon returned to the tank 1035 (which is a storage vessel/contactor) for additional CO₂ capture. Intake air enters the system 1000 from CO₂ source 1040 (e.g., ambient air) and pure CO₂ released along exhaust 1055 that is suitable for storage or for further processing. In some embodiments, the pH at one side of the NL 1050 is around 12 and less than around 2 at the other side.

The various reaction steps for generic redox couples during the charge mode that occur in the different layers of the cell as shown in FIG. 10 are also listed below:

| Component | | Reaction |
|---|---|---|
| Contactor, | s_{C,1}: | OH⁻ + CO₂ [symbol] HCO₃⁻ |
| | s_{C,2}: | OH⁻ + HCO₃⁻ [symbol] CO₃²⁻ + H₂O |
| Negative, | s_{-,1}: | O₋ + AOH + e⁻ [symbol] R₋ + OH⁻ |
| | s_{-,2}: | OH⁻ + A⁺ [symbol] AOH |
| Neg OR: | | O₋ + A⁺ + e⁻ [symbol] R₋ |
| NL, | s_{NL,1}: | H⁺ + CO₃²⁻ [symbol] HCO₃⁻ |
| | s_{NL,2}: | H⁺ + HCO₃⁻ [symbol] H₂O + CO₂ |
| | s_{NL,3}: | H⁺ + AOH [symbol] A⁺ + H₂O |
| Positive, | s_{+,1}: | R₊ [symbol] O₊ + H⁺ + e⁻ |

| | |
|---|---|
| Cell OR: | O₋ + AOH + R₊ [symbol] R₋ + H₂O + O₊ |
| CO₂ Capture: | CO_{2, f} [symbol] CO_{2, p} |

During the discharge cycle of the storage cycle for the cell shown in system 1000, since CO₂ capture is not involved, the reactions that occur are

| Component | | Reaction |
|---|---|---|
| Negative, | s_{-,1}: | R₋ + OH⁻ [symbol] O₋ + AOH + e⁻ |
| | s_{-,2}: | AOH [symbol] OH⁻ + A⁺ |
| Neg OR: | | R₋ [symbol] O₋ + A⁺ + e⁻ |
| NL, | s_{NL,3:} | A⁺ + H₂O [symbol] H⁺ + AOH |
| Positive, | s_{+,1}: | O₊ + H⁺ + e⁻ [symbol] R₊ |

| | |
|---|---|
| Cell OR: | R₋ + H₂O + O₊ [symbol] O₋ + AOH + R₊ |

As a more concrete example, if the same redox couples at the two electrodes were used as those discussed in a previous example, then during the charge process

| Component | | Reaction |
|---|---|---|
| Neg, | s_{-,1}: | Na₂⁺Zn(OH)₄²⁻ + 2e− [symbol] Zn + 2NaOH + 2OH⁻ |
| | s_{-,2}: | 2OH⁻ + 2Na⁺ [symbol] 2NaOH |
| Neg OR: | | Na₂⁺Zn(OH)₄²⁻ + 2Na⁺ + 2e⁻ [symbol] Zn + 4NaOH; Φ_{-, 0}^{o} = −1.21 V |
| NL, | s_{NL,1}: | H⁺ + CO₃²⁻ [symbol] HCO₃⁻ |
| | s_{NL,2}: | H⁺ + HCO₃⁻ [symbol] H₂O + CO₂ |
| | s_{NL,3}: | 2H⁺ + 2NaOH [symbol] 2Na⁺ + 2H₂O |
| Pos, | s_{+,1}: | 2H₂⁺[Fe²⁺Cl₄⁻] [symbol] 2H⁺[Fe³⁺Cl₄⁻] + 2H⁺ + 2e⁻; Φ_{+, 0}^{o} = +0.77 V |

| | |
|---|---|
| OR: | Na₂⁺Zn(OH)₄²⁻ + 2H₂⁺[Fe²⁺Cl₄⁻] [symbol] Zn + 2H⁺[Fe³⁺Cl₄⁻] + 2NaOH + 2H₂O |
| CO₂ Capture: | CO_{2, f} [symbol] CO_{2, p} |

while the electrode reactions during discharge mode are

| Component | | Reaction |
|---|---|---|
| Neg, | s_{-,1}: | Zn + 2NaOH + 2OH⁻ [symbol] Na₂⁺Zn(OH)₄²⁻ + 2e⁻ |
| | s_{-,2}: | 2NaOH [symbol] 2OH⁻ + 2Na⁺ |
| Neg OR: | | Zn + 4NaOH [symbol] Na₂⁺Zn(OH)₄²⁻ + 2Na⁺ + 2e⁻; Φ_{-, 0}^{o} = −1.21 V |
| NL: | S_{NL,3}: | 2Na⁺ + 2H₂O [symbol] 2H⁺ + 2NaOH |
| Pos, | s_{+,1}: | 2H⁺ [Fe³⁺Cl₄⁻] + 2H⁺ + 2e⁻ [symbol] 2H₂⁺[Fe²⁺Cl₄⁻]; Φ_{+, 0}^{o} = +0.77 V |

| | |
|---|---|
| OR: | Zn + 2H⁺[Fe³⁺Cl₄⁻] + 2NaOH + 2H₂O [symbol] Na₂⁺Zn(OH)₄²⁻ + |
| | 2H₂⁺[Fe²⁺Cl₄⁻]; V₀^{o} = 1.99 V |

The resulting cell Nernst potential, V₀^{o}=(Φ_{+,0}^{o})_{pH=0}−(Φ_{-,0}^{o})_{pH=14}=+0.77−(−1.22)=1.99 V, and hence, this is a good system, although the negative Zn electrode tends to suffer from hydrogen evolution owing to its low standard electrode potential, as evident from FIG. 6.

As another example of redox couples for the ⊖-CEM1-NL-CEM2-⊕ cell configuration shown in FIG. 10, if the conventional redox couples of the vanadium redox flow battery (VRFB) for both the negative and the positive electrodes are used, e.g., the negative electrode with the V^{3+/2+} cation and NaOH as the supporting electrolyte, while for the positive electrode the V⁵⁺/V⁴⁺ redox couple is used in an acidic electrolyte, e.g., with HCl.

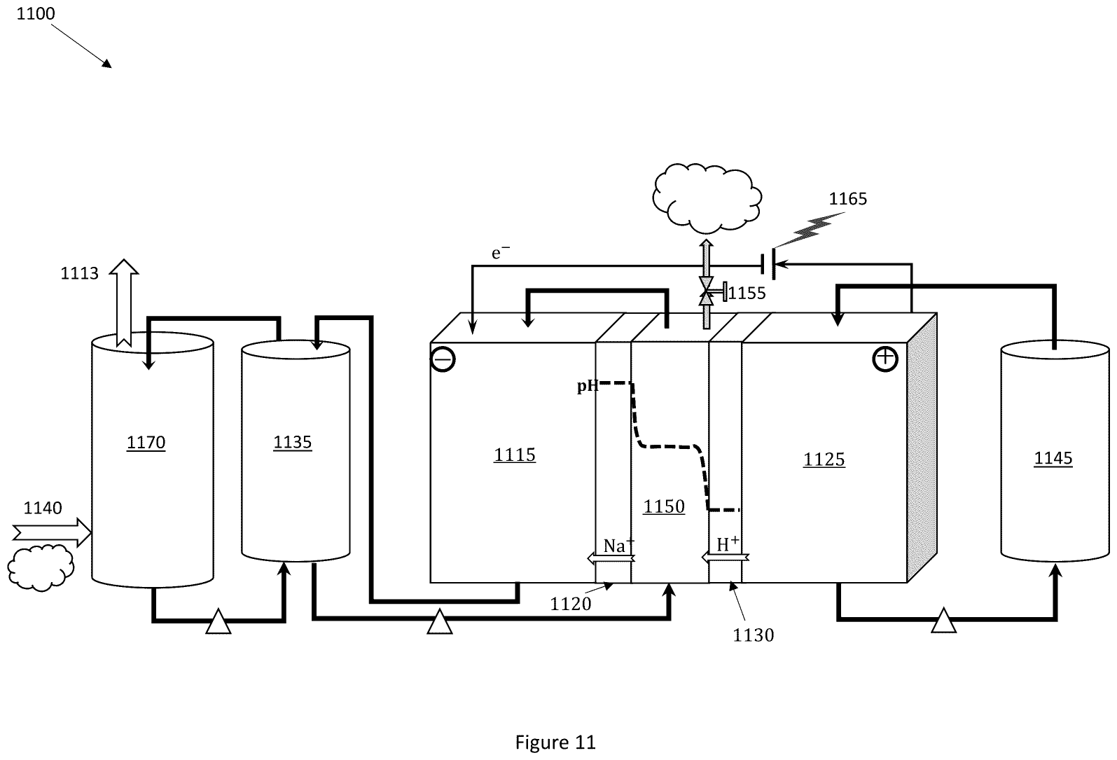

FIG. 11 shows such an embodiment, where the system 1100 is similar to that of 1000 of FIG. 10. A negolyte tank 1135 is fed with CO₂ but includes a CO₂ absorber 1170 that receives air from a CO₂ source 1140 and is separate from the cell and its storage tanks 1135, 1145. The input gas can be a CO₂ source such as flue gas or ambient air. Cleansed exhaust leaves the absorber 1170 (and/or the negolyte tank 1035) via outlet 1013. Acidic posolyte is contained in posolyte tank 1145. Pure CO₂ exits the NL 1150 along exhaust 1155. Load 1165 is electrically connected to the unit.

The exemplary reactions in the different components of the system 1100 during the charge mode are

| Component | Reaction |
|---|---|
| Absorber: | NaOH + CO_{2, f} [symbol] NaHCO₃ |
| −ve: | V³⁺(OH⁻)₃ + Na⁺ + e⁻ [symbol] V²⁺(OH⁻)₂ + NaOH; Φ_{-, 0}^{o} ≈ −1.09 V |
| NL: | H⁺ + NaHCO₃ [symbol] Na⁺ + H₂O + CO_{2, p} |
| +ve: | VO²⁺(Cl⁻)₂ + H₂O [symbol] VO₂⁺(Cl⁻) + HCl + H⁺ + e⁻; Φ_{+, 0}^{o} = +1.004 V |
| Cell: | V³⁺(OH⁻)₃ + VO²⁺(Cl⁻)₂ [symbol] V²⁺(OH⁻)₂ + VO₂⁺(Cl⁻) + HCl; V₀^{o} ≈ 2.094 V |
| Carbon Capture: | CO_{2, f} [symbol] CO_{2, p} |

During the discharge mode, the absorber, electrode, and the cell overall reactions are

| Component | Reaction |
|---|---|
| −ve: | V²⁺(OH⁻)₂ + NaOH [symbol] V³⁺(OH⁻)₃ + Na⁺ + e⁻; (Φ_{-, 0}^{o})_{pH=14} ≈ −1.09 V |
| NL: | Na⁺ + H₂O [symbol] H⁺ + NaOH |
| +ve: | VO₂⁺(Cl⁻) + HCl + H⁺ + e⁻ [symbol] VO²⁺(Cl⁻)₂ + H₂O; (Φ_{+, 0}^{o})_{pH=0} = +1.004 V |
| Cell: | V²⁺(OH⁻)₂ + VO₂⁺(Cl⁻) + HCl [symbol] V³⁺(OH⁻)₃ + VO²⁺(Cl⁻)₂; V₀^{o} ≈ 2.094 V |

NaOH and Na₂CO₃ (aq) travel from the negolyte tank 1135 to the absorber 1170

When all the processes in one complete cycle (CO₂ absorption, cell charge, and cell discharge) are combined, the only net effect is carbon capture, CO_{2,f}⇄CO_{2,p}, besides electricity exchange. Thus, the overall system simply acts as a carbon capture device, if all of the energy stored during charging is simply reused to drive the carbon capture. However, it would usually be more profitable to use some of the stored energy for accommodating grid demand variability at the different time-scales.

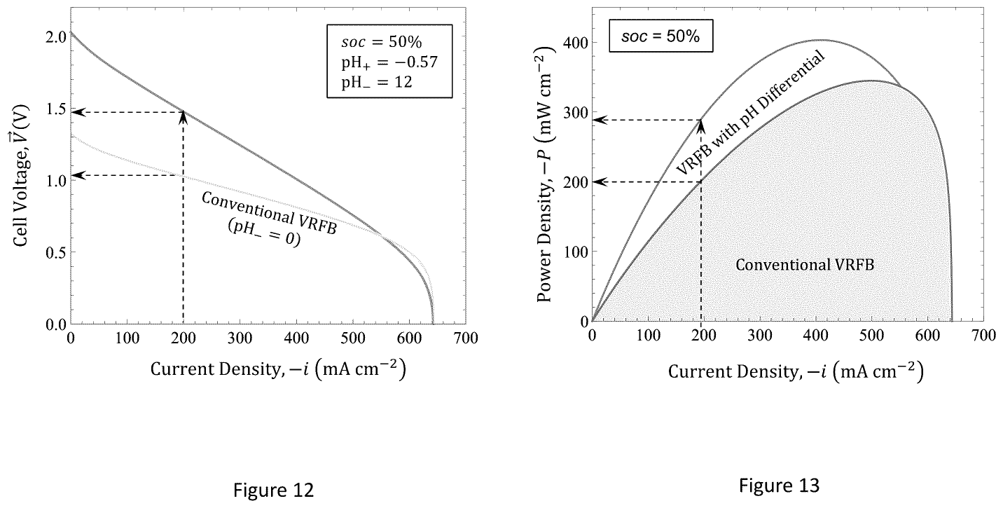

FIGS. 12 and 13 provide a comparison of the discharge polarization curve and power density, respectively, for a conventional VRFB (without a pH differential) and for a VRFB with a pH differential, from the standpoint of energy storage.

For example, for an operating current density of 200 mA cm⁻², the cell voltage is roughly 1.48 V in comparison to 1.08 V in the conventional VRFB (FIG. 12). The resulting 400 mV improvement is significant, and results in a higher power density during the discharge phase as shown in FIG. 13. The higher slope of the CC-RFB curve is because of the additional resistance of the NL and an additional CEM in the proposed cell in composition to the conventional VRFB cell.

There is corresponding rise in the voltage during charging mode as well. For instance, for a common current density of |i|=200 mA cm⁻² during charge and discharge phases, the discharge potential \vec{V}=1.48 V, while the charge potential for this current density is [symbol] =2.78 V.

The resulting energy storage cycle efficiency for uniform current density over the cycle

$${\overleftrightarrow{ε}}_{E S} \approx \vec{\frac{V}{\overleftarrow{V}}} = \frac{1.48}{2.78} = 53 \%$$

which compares with a corresponding efficiency of 63% for the conventional VRFB without a pH differential. Similarly, the cell efficiency for energy storage at 150 mA cm⁻² drops from 69% for conventional VRFB to 60% for the VRFB with a pH differential. In short, the pH differential results in a higher energy density and a smaller stack for a given duty, but at the expense of a reduction in cycle efficiency because of the potential drops in the additional layers needed to sustain the pH differential.

The above estimates include the work of carbon capture as well. If this were excluded, i.e., for the case of a pH differential RFB without CC, the efficiencies are somewhat higher. On the other hand, if the work expenditure attributable to carbon capture is that due to thermodynamic work of carbon capture, V_{0,CC}, plus twice the Ohmic losses in the additional layers to sustain the pH, i.e., CEM1 and NL, then the energy efficiency of CC may be estimated via the expression the expression provided above.

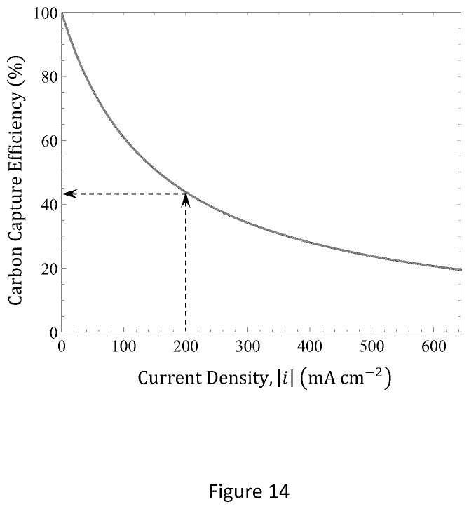

This is plotted in FIG. 14 as a function of the operating current density assuming n_{CC}=1, and shows that impressive direct air capture efficiencies can be obtained, e.g., an efficiency of 44% at a current density of 200 mA cm⁻². To this must be added the work of absorption in the absorption column. Nonetheless, the resulting efficiencies will be significantly better than, e.g., the 5% efficiency, for instance, in the Carbon Engineering process.

As another example of the ⊖-CEM1-NL-CEM2-⊕ cell configuration (e.g., as discussed with respect to FIG. 10), the VO²⁺/VO₂⁺ redox couple for the acidic positive electrode is used as above, but for the negative electrode the [Fe(TEA)OH]²⁻/[Fe(TEA)OH]⁻ redox couple is used, where TEA denotes the triethanolamine ligand, in the alkaline negolyte such as NaOH solution. Then the reactions during the discharge mode are

| Component | Reaction |
|---|---|
| −ve: | Na₂⁺[Fe(TEA)OH]²⁻ [symbol] Na⁺[Fe(TEA)OH]⁻ + Na⁺ + e⁻; (Φ_{-, 0}^{o})_{pH=14} = −1.05 V |
| NL: | Na⁺ + H₂O [symbol] H⁺ + NaOH |
| +ve: | VO₂⁺(Cl⁻) + HCl + H⁺ + e⁻ [symbol] VO²⁺(Cl⁻)₂ + H₂O; (Φ_{+, 0}^{o})_{pH=0} = +1.004 V |
| Cell: | Na₂⁺[Fe(TEA)OH]²⁻ + VO₂⁺(Cl⁻) + HCl [symbol] Na⁺[Fe(TEA)OH]⁻ + VO²⁺(Cl⁻)₂ + |
| | NaOH; V₀^{o} ≈ 2.054 V |

Thus, the cell Nernst voltage at a soc=0.5, and for direct air capture,

$${\overleftarrow{V}}_{0} = 2.064 + ( \frac{8.314 \times 298}{2 \times 96 , 485} ) ln {( \frac{0.5}{0.5} )}^{2} + ( \frac{8.314 \times 298}{1.47 \times 96 , 485} ) ln ( \frac{1}{0.00041} ) = 2.05 4 + 0 + 0.1 \; 36 = 2.19 V$$

during charge, while during discharge, \vec{V}₀=2.054 V. This is another good system for combined energy storage and carbon capture, since TEA complexes are routinely used for carbon capture.

If on the other hand, the Fe³⁺/Fe²⁺ redox couple was used for the posolyte instead of the VO²⁺/VO₂⁺ redox couple, then the reactions during the discharge mode of the all iron CC-RFB system are

| Component | Reaction |
|---|---|
| −ve: | Na₂⁺[Fe(TEA)OH]²⁻ [symbol] Na⁺[Fe(TEA)OH]⁻ + Na⁺ + e⁻; (Φ_{-, 0}^{o})_{pH=14} = −1.05 V |
| NL: | Na⁺ + H₂O [symbol] H⁺ + NaOH |
| +ve: | Fe³⁺(Cl₃⁻) + H⁺ + e⁻ [symbol] Fe²⁺(Cl₂⁻) + HCl; (Φ_{+, 0}^{o})_{pH=0} = +0.77 V |
| Cell: | Na₂⁺[Fe(TEA)OH]²⁻ + Fe³⁺(Cl₃⁻) + H₂O [symbol] Na⁺[Fe(TEA)OH⁻ + Fe²⁺(Cl₂⁻) + HCl + |
| | NaOH; V₀^{o} ≈ 1.82 V |

In summary, twin CEMs, one for the proton, H⁺, and the other for the alkali cation, A⁺, appears to be especially advantageous for the goal of combined carbon capture with energy storage. This is so as the CEMs are better developed commercially and have longer lives, especially those based on fluoropolymers, since the OH-ions are very reactive and destroy the AEMs. Further, the ionic conductivities in CEMs are better and also anionic redox species can be largely excluded from them reducing crossover.

However, in principle one could also devise the ⊖-AEM1-NL-AEM2-⊕ arrangement which might also be advantageous once improved AEMs are available.

4) An Arrangement with Same Redox Molecule at Both Electrodes for Carbon Capture: When the goal is only carbon capture, an attractive alternative may be to use the same redox couple in both the negolyte with an alkaline supporting electrolytes such as KOH, as well as in the posolyte with an acidic supporting electrolyte, e.g., HCl, provided the chosen molecule is soluble in and compatible with both electrolytes.

An example of such a redox couple is the ferro-/ferri-cyanate couple which is stable under both alkaline and acidic conditions. In such a case, V=0. Then, e.g., the electrode reactions for the ⊖-CEM1-NL-CEM2-⊕ scheme (FIG. 10, but with R₋=R₊ and O₋=O₊) are:

| Component | Reaction |
|---|---|
| Neg: | A₃⁺[Fe^{III}(CN)₆]³⁻ + AOH + e⁻ [symbol] A₄⁺[Fe^{II}(CN)₆]⁴⁻ + OH⁻ |
| | OH⁻ + A⁺ [symbol] AOH |
| Neg OR: | A₃⁺[Fe^{III}(CN)₆]³⁻ + A⁺ + e⁻ [symbol] A₄⁺[Fe^{II}(CN)₆]⁴⁻; |
| | (Φ_{-, 0}^{o})_{pH=0} = +0.358 V |
| Pos: | H₄⁺[Fe^{II}(CN)₆]⁴⁻ [symbol] H₃⁺[Fe^{III}(CN)₆]³⁻ + H⁺ + e⁻; |
| | (Φ_{-, 0}^{o})_{pH=0} = +0.358 V |

while the reactions in other layers remain the same. Alternately, this could be implemented in a scheme with an ⊖-CEM-NL-AEM-⊕ configuration.

For the systems shown in which the reaction at both electrodes is the same, (V₀^{o})_{pH=0}→0, and the Nernst potential for the electrode reactions is based primarily on the pH differential and the soc, i.e.,

$${\overleftarrow{V}}_{0} = \frac{R T}{n F} {ln ( \frac{s o c}{1 - s o c} )}^{2} + ( \frac{R T}{{n}_{C C} F} ) ln ( \frac{{p}_{C {O}_{2} , p}}{{p}_{C {O}_{2} , f}} ) + 2.3026 ( \frac{R T}{F} ) ( {pH}_{-} - {pH}_{+} )$$

for the charge mode. Thus, the cell voltage can be minimized and the CC efficiency can be maximized.

5) Arrangement Using Only a Single Liquid Redox Electrolyte: The necessity of the usage of a finite amount of negolyte and posolyte means that the state-of-charge changes with time, affecting the efficacy of the process gradually and also limiting in a cyclic process the phase for carbon capture, before the electrolytes solutions are replenished or renewed, e.g., by following the reverse of the carbon capture/charging process, i.e., via discharging the solutions. If inexhaustible materials such as air or water could be utilized at one or both electrodes, then the carbon capture process could be carried out in a given cell in a more uninterrupted manner.

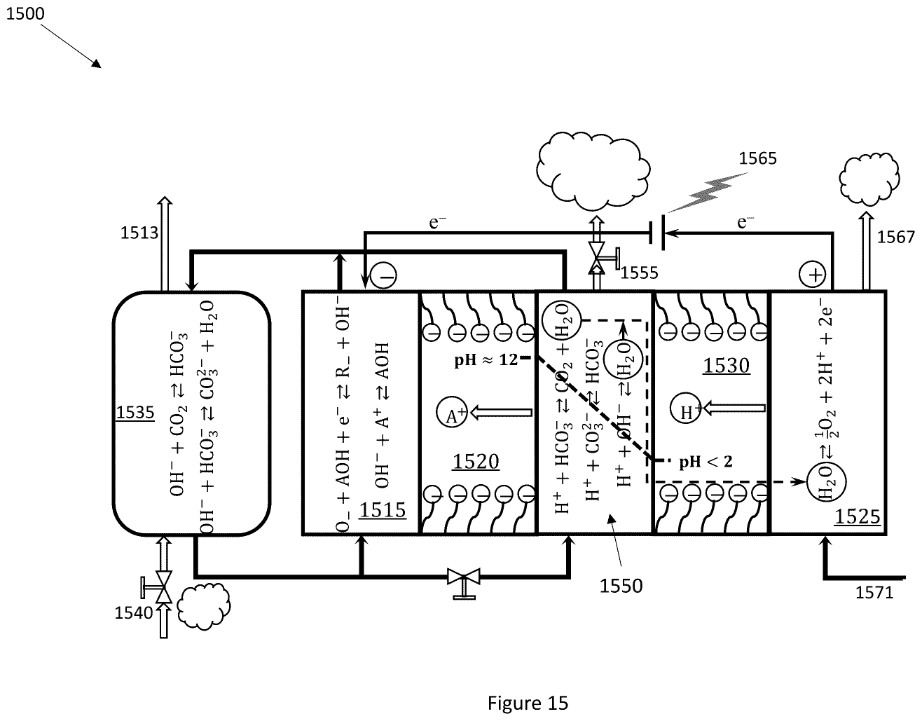

FIG. 15 shows a system 1500 using a ⊖-CEM1-NL-CEM2-⊕ configuration where CEM1 1520 and CEM2 1530 sandwich NL 1550. Here, the active molecule in the posolyte has been replaced by the H₂O/O₂ redox couple, which may be supplied from outside, or recycled within as indicated in the FIG. 15, while the negolyte in tank 1535 is assumed to be a conventional redox molecule, e.g., quinone. An advantage of this scheme is that it produces pure oxygen that exits via outlet 1567 in addition to producing a pure CO₂ stream that exits at 1555. The resulting oxygen could be used for therapeutic or industrial purposes, including for oxy-combustion of fuels to produce pure CO₂, as in the Carbon Engineering process. The soc of the conventional negolyte redox molecule must still be restored, either chemically, or electrochemically, as for instance during the discharge phase in a cell.

As a specific example, let us select the oxygen electrode reaction (OER) at the positive electrode and β-anthraquinone sulfonic acid (H₂aQ) as the redox molecule in the negolyte. Then, during the carbon capture/charge cycle, it is seen in FIG. 15 that the processes at the negative electrode, contactor, and the NL remain then unchanged as discussed above in connection with FIG. 10. The only change is in the reaction at the positive electrode, where water that is input at 1571 reacts to evolve pure oxygen, i.e.,

$$\text{Positive:} {H}_{2} O ⇄ \frac{1}{2} {O}_{2} + 2 {H}^{+} + 2 {e}^{-} ; {Φ}_{+ , 0}^{o} = + 1.229 V$$

The positive electrode in this case would be identical to that in a PEM electrolyzer, e.g., comprising of a titanium foam gas-diffusion layer (Ti-GDL) along with an IrO₂, or a Ru—IrO₂, catalyst layer, interspersed with Nafion gel, and followed by a CEM, e.g., Nafion® 1135, or Nafion® 115.

During the discharge cycle, on the other hand, since there is no CO₂, the reactions are:

| Electrode | | Reaction |
|---|---|---|
| Anode, | s_{-,1}: | A₂aQ + 2OH⁻ [symbol] aQ²⁻ + 2AOH + 2e⁻; (Φ_{-,0}^{o})_{pH = 0} = + |
| | | 0.187 V |
| | s_{-,2}: | 2AOH [symbol] 2OH⁻ + 2A⁺ |
| NL, | s_{NL,3}: | 2A⁺ + 2H₂O [symbol] 2H⁺ + 2AOH |
| Cathode, | s_{+,1}: | ½O₂ + 2H⁺ + 2e⁻ [symbol] H₂O; (Φ_{+,0}^{o})_{pH = 0} = + 1.229 V |

| | |
|---|---|
| Cell OR: | A₂aQ + H₂O+ 1/2O₂ [symbol] aQ²⁻ + 2AOH; (V₀^{o})_{pH =0} = |
| | 1.042 V |

The advantage of using the oxygen electrode reaction at the positive electrode is that air can be fed during the discharge phase, and no storage or recharging of the posolyte is needed. This is somewhat similar to a PEM water electrolyzer/fuel cell used cyclically for energy storage. However, since hydrogen electrode reaction (HER) is not used at the negative electrode in the above arrangement, it avoids storage of hydrogen and use of any precious metal catalyst needed for it. A disadvantage is that the overpotentials of OER are much higher than for a typical redox molecule, and precious metal catalyst is needed at the positive electrode. The resulting increased cost and lower efficiency is compensated by the generation of pure oxygen.

For the scheme in FIG. 15, during the charge phase, the Nernst potential

$${\overleftarrow{V}}_{0} = {( {V}_{0}^{o} )}_{p H = 0} + ( \frac{8.314 \times 298}{1.47 \times 96 , 485} ) ln ( \frac{1}{0.00041} ) + 2.3026 ( \frac{8.314 \times 298}{96 , 485} ) ( 12 - 0 ) = 1. 42 + 0.136 + 0.71 = 1.8 \; 88 V$$

while in the discharge phase, in the absence of CO₂, the Nernst potential

$${\overleftarrow{V}}_{0} = {V}_{0}^{o} + 2.3026 ( \frac{8.314 \times 298}{96 , 485} ) ( 12 - 2 \times 0 ) = 1.7 \; 52 V$$

In other words, the flow battery voltage for energy storage is significantly higher than generally possible in a battery based on an aqueous electrolyte-based system. Additionally, pure oxygen is produced, which is a valuable product. In reality, the estimate V_{ΔpH}=2.3026(RT/F)(pH₋−2 pH₊) used above is an overprediction for redox negolyte molecule with more than one exchangeable proton or cation, as is the case for the anthraquinone example used here, since at low pH or when the concentration of protons is high, only the exchange of second proton is affected.

Nonetheless, this system is potentially attractive for combined energy storage and carbon capture because of the higher cell voltage and power density. Further, it should be evident that the system can be implemented with alternate membrane structures, e.g., an ⊖-AEM-NL-CEM-⊕ configuration.

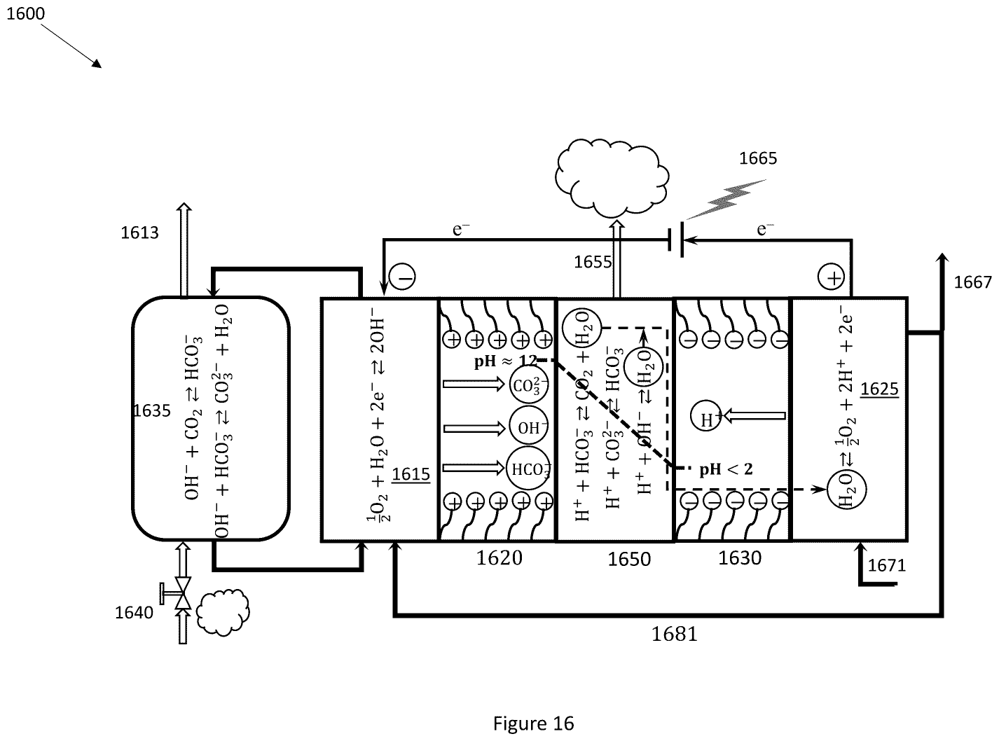

6) Embodiments without Redox Molecules for Continuous Carbon Capture: In another embodiment with the goal of continuous carbon capture without the use of any special redox active species even in the negolyte, but still including the supporting electrolyte, e.g., NaOH, or an absorbent in an aqueous solution to capture the CO₂, the system 1600 could take the form shown in FIG. 16 with an ⊖-AEM-NL-CEM-⊕ configuration. In this the same abundantly available redox couple, i.e., H₂O/O₂, is used at both electrodes, just operating in the reverse direction and at different pH.

Carbonated negolyte travels from the tank 1635 to the negative electrode and decarbonated negolyte from the electrode 1615 to the tank 1635. Water is input at 1671. Oxygen exits at 1667. Oxygen also transported to the negative electrode 1615.

It is further conceivable that it may not be necessary to recycle oxygen from the positive to the negative electrode as shown in FIG. 16, as the sparged supporting electrolyte solution may have enough dissolved oxygen, especially for the case of direct air capture, to sustain a desired current. In fact, the direct air capture of CO₂ could conceivably be accomplished in situ within the negative electrode chamber.

The various reaction steps that occur in the carbon capture mode then are:

| Component | | Reaction |
|---|---|---|
| Contractor, | s_{C,1}: | OH⁻ + CO₂ [symbol] HCO₃⁻ |
| | s_{C,2}: | OH⁻ + HCO₃⁻ [symbol] CO₃²⁻ + H₂O |
| Cathode, | s_{-,1}: | ½O₂ + H₂O + 2e⁻ [symbol] 2OH⁻; (Φ_{-,0}^{o})_{pH = 14} = +0.401 V |
| NL, | S_{NL,1}: | H⁺ + CO₃²⁻ [symbol] HCO₃⁻ |
| | S_{NL,2}: | H⁺ + HCO₃⁻ [symbol] H₂O + CO₂ |
| | S_{NL,3}: | H⁺ + OH⁻ [symbol] H₂O |
| Anode, | s_{+,1}: | H₂O [symbol] ½O₂ + 2H⁺ + 2e⁻; (Φ_{+,0}⁰)_{pH = 0} = +1.229 V |

| | |
|---|---|
| CO₂ Capture: | CO_{2,f} [symbol] CO_{2,p} |

The system 1600 shown in FIG. 16, the positive electrode is as described in connection with FIG. 15, while the negative electrode is similar to that for an electrolyzer based on an AEM, e.g., Fumasep® FAA membrane, Selemion® membrane, PiperION® membrane, or a Sustainion® membrane adjacent to an appropriate (e.g., Ag or Ni) catalyst and a graphite GDL electrode.

The potential of the negative electrode cited above already includes the effect of pH, so that the standard cell voltage

$${V}_{0}^{o} = {( {Φ}_{+ , 0}^{o} )}_{p H = 0} - {( {Φ}_{- , 0}^{o} )}_{p H = 14} = 1.229 - 0.401 = + 0.8 \; 28 V$$

which is simply that due to the pH differential, i.e.,

$${V}_{0}^{o} = 2.3026 ( \frac{R T}{F} ) ( {pH}_{-} - {pH}_{+} ) = 2.3026 ( \frac{8.314 \times 298}{96 , 485} ) ( 14 - 0 ) = + 0.828 V$$

In other words, if the same redox couple could be used at both electrodes, i.e., under both acidic and alkaline conditions, then the cell voltage is minimized and the carbon capture efficiency is increased.

The ideal CC efficiency for this cell design for the case of direct air capture, assuming n_{CC}=1.47 as above

$${ϵ}_{e C C} = \frac{{V}_{0 , CC}}{{V}_{0 , CC} + {V}_{0}^{o}} = \frac{0.1362}{0.1362 + 0.828} = 1 4.1 \%$$

However, the actual efficiency would be lower, between 5%-10%, when the electrode overpotentials are included in the cell voltage. Even so, these efficiencies are comparable to those of the Carbon Engineering process.

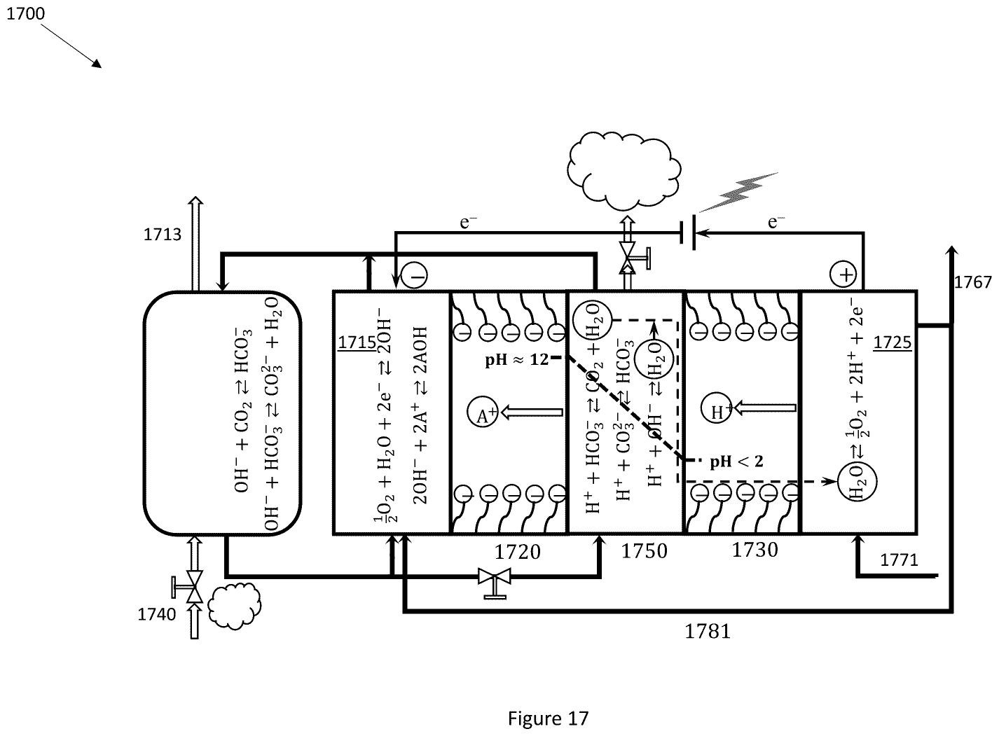

FIG. 17, on the other hand, is a system 1700 similar to the above scheme but in a configuration with two CEMs. The electrodes would be similar in structure to those described for FIGS. 15 and 16. In other words, because of the need for expensive/precious metal catalysts in these cells, their simplicity in design is offset by the higher cost. On the other hand, there is no energy storage. However, carbon capture is continuous and not simply in the charge mode, so that roughly only half the cells are needed for carbon capture.

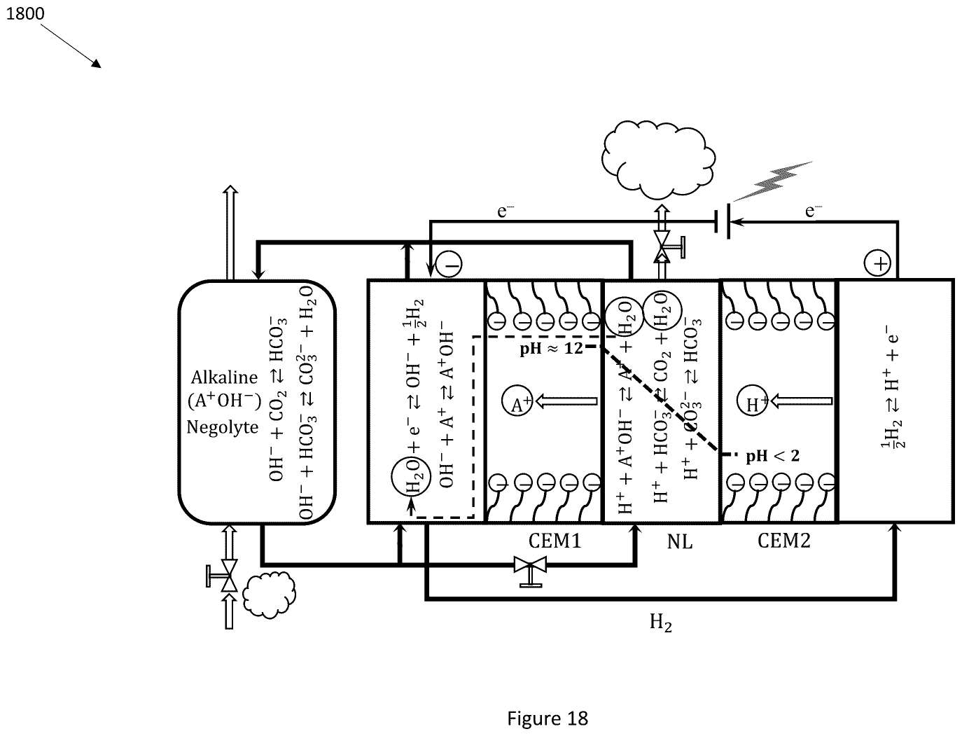

Another system 1800 with 2 CEMs is shown in FIG. 18 that uses the hydrogen electrode reaction (HER) rather than OER, with the reductant H₂ being circulated rather than the oxidant O₂ being circulated. The advantage of this system is the significantly lower overpotentials of these electrodes on comparison to those with OER, as well as lower precious metal catalyst loadings. This scheme can also alternately be based on an AEM-CEM configuration.

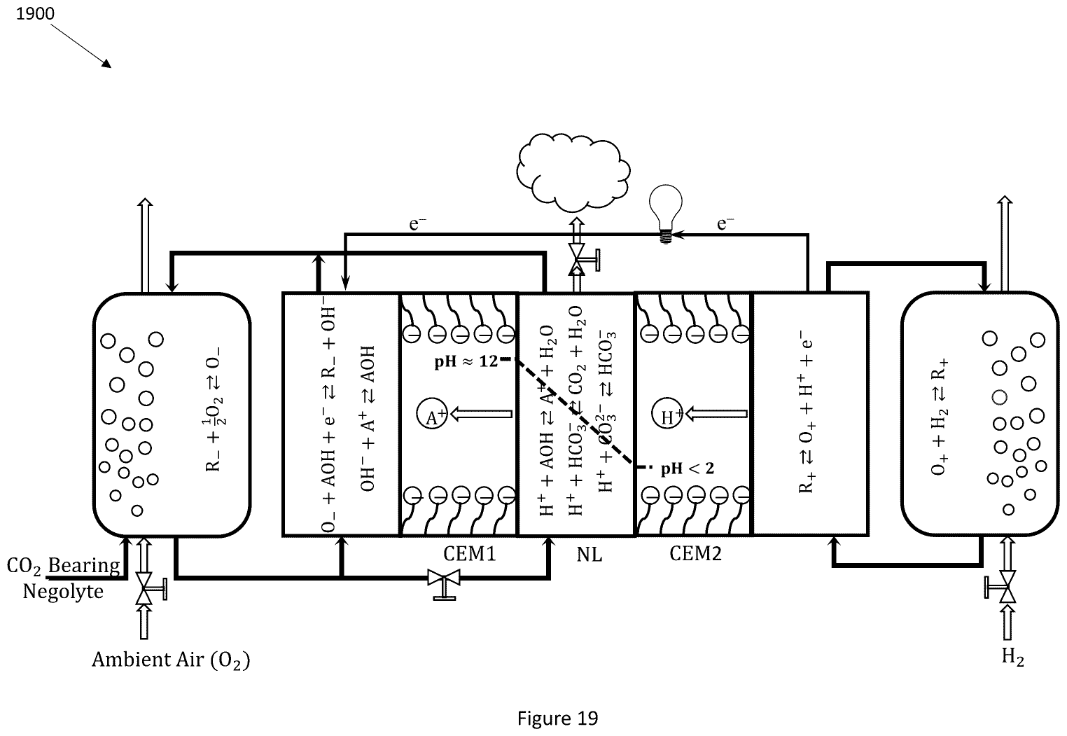

7) Embodiment as a Carbon-Capturing Regenerative Redox Fuel Cell: An example of a carbon-capturing regenerative redox fuel cell (CC-RFC) in which, unlike a rechargeable flow battery, the cell is regenerated not via electric power, but rather chemically by a fuel, e.g., H₂ or methanol, and an oxidant, e.g., O₂ (from air), as shown schematically in FIG. 19 for the case of H₂ and O₂ as the reductant and the oxidant in a CC-RFC cell with the CEM1-NL-CEM2 configuration.

In the system 1900 shown in FIG. 19, the redox couples work as redox catalysts for the H₂ oxidation (HOR) and for the oxygen reduction reaction (ORR). The CC-RFCs are different from CC-RFBs as they, like fuel cells, can be operated continuously so long as a supply of the fuel and the oxidant are available, since the soc does not change with time.

As an example, the VO²⁺/VO₂⁺ redox couple can be used for the acidic electrolyte and the [Fe(TEA)OH]²⁻/[Fe(TEA)OH]⁻ redox couple for the basic electrolyte. The redox couples must be chosen with potentials that allow them to be reduced by H₂ and oxidized by O₂.

For the chosen redox couples, the reactions in the absorber and in the cell, as before, are

| Component | Reaction |
|---|---|
| Absorber: | NaOH + CO_{2 ,f} [symbol] NaHCO₃ |
| −ve: | Na⁺[Fe(TEA)OH]⁻ + Na⁺ + e⁻ [symbol] Na₂⁺ [Fe(TEA)OH]²⁻; (Φ_{-,0}^{o})_{pH = 14} = −1.05 V |
| NL: | H⁺ + NaHCO₃ [symbol] Na⁺ + H₂O + CO_{2,p} |
| +ve: | VO²⁺ (Cl⁻)₂ + H₂O [symbol] VO₂⁺(Cl⁻) + HCl + H⁺ + e⁻; (Φ_{+,0}^{o})_{pH = 0} = +1.004 V |
| Cell: | Na⁺[Fe(TEA)OH]⁻ + VO²⁺ (Cl⁻)₂ [symbol] Na₂⁺ [Fe(TEA)OH]²⁻ + VO₂⁺(Cl⁻) + HCl; V₀^{o} = 2.054 V |
| Carbon Capture: | CO_{2,f} [symbol] CO_{2,p} |

In addition, the chemical regeneration reactions assuming H₂ and O₂ as the reductant and the oxidant in the reactors are

| Component | Reaction |
|---|---|
| Negolyte Regen: | Na₂⁺ [Fe(TEA)OH]²⁻ + ½(H2O + ½O₂) [symbol] Na⁺[Fe(TEA)OH]⁻ + NaOH |
| Posolyte Regen: | VO₂⁺(Cl⁻) + HCl + ½H2 [symbol] VO2+(Cl⁻)2 + H₂O |

When the above reactions in the absorber, the cell and in the chemical regeneration reactors are combined, there result simply the fuel cell overall reaction along with carbon capture,

$$\text{Redox Fuel Cell:} \frac{1}{2} ( {H}_{2} + \frac{1}{2} {O}_{2} ) ⇄ \frac{1}{2} {H}_{2} O$$

$$\text{Carbon Capture:} {CO}_{2 , f} ⇄ {CO}_{2 , p}$$

Catalysts may well be needed for the chemical regeneration steps.

Further, it is possible that partial regeneration of the negolyte redox couple may occur in the CO₂ absorber itself because of the presence of O₂. For instance, if the anthraquinone sulfonic acid (H₂aQ) is used as the redox molecule in the negolyte, it is sensitive to oxygen. However, that is not an issue here, since oxidation is the goal for its regeneration here. The oxygen sensitivity of the reduced form of a redox couple may, in fact be exploited for its facile oxidation.

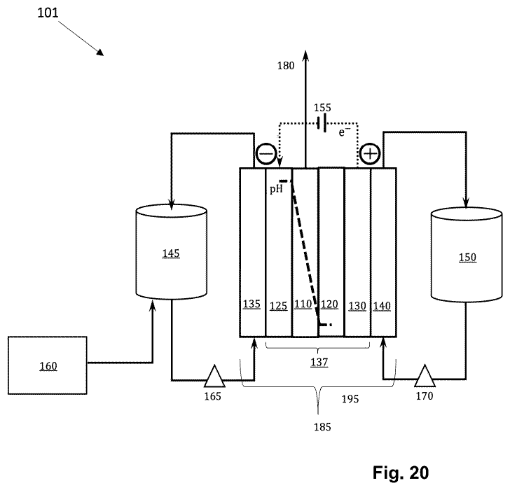

FIG. 20 is an alternative configuration employing a single ion-exchange membrane in the membrane-electrode assembly (MEA). As alluded above, various alternations may be performed with the ion exchange membranes and neutralyte layers. Either of the ion exchange membranes (IEMs) may be cation (CEM) or anion (AEM) exchange membranes, and may occur on alternating sides of the neutralyte. Further, the neutralyte itself may simply be a porous membrane. These and related configurations are now discussed in further detail.

Referring to FIGS. 1 and 20, In the description of FIG. 1 the neutralyte layer (NL) is similar to the separator layer in conventional batteries, and is comprised of a porous inert polymer or a ceramic membrane. Suitable polymers, for instance, include those chemically compatible with the supporting electrolytes of the presently described system, including high density polyethylene, polypropylene, polyvinylidene difluoride (PVDF), or poly-tetrafluoroethylene (PTFE). Porous ceramic membranes are chemically compatible oxides, nitrides, or carbides of various metals, e.g., Al₂O₃, SiO₂, ZrO₂, TiO₂, NiO, SiC, etc.

As with the configurations above, a pH differential forms across the neutralyte layer for providing a voltage differential. It follows that upon a connection from the positive and negative electrodes to an electric load, the pH differential results in a difference in potential between the positive electrode and the negative electrode for forming a current flow to the electric load. A fluidic connection may supplying and circulating the alkaline negative electrolyte, and/or a fluidic connection may also supplying and circulating the acidic positive electrolyte. In an alternative configuration, the IEM1 115 or the IEM2 120 in FIG. 1 is replaced by a porous diaphragm (PD), which is not ion-selective, rather than an ion-exchange membrane. Thus, both anions and cations are able to diffuse across it to the NL110. FIG. 20 illustrates a flow electrochemical cell device including a pair of opposed electrodes including a negative electrode configured to be in fluid communication with an alkaline negative electrolyte for producing CO₂-bearing anions, and a positive electrode configured to be in fluid communication with an acidic positive electrolyte. As above, the alkaline negative electrolyte and the acidic positive electrolyte generally support redox active molecules that participate in redox reactions to store electrical energy. However, only a single porous diaphragm in contact with an opposed electrode of the pair of opposed electrodes is employed, as opposed to two IEMs flanking the neutralyte. The intermediate neutralyte layer (neutralyte) is adjacent the porous diaphragm and between the pair of opposed electrodes; an opposed side of the porous diaphragm has no IEM. Only the porous diaphragm and the neutralyte layer are needed to maintain a pH differential between the negative electrode and the positive electrode based on the redox reactions.

Referring to FIG. 20, in an alternative embodiment of FIG. 1, the IEM1 115 in FIG. 1 is omitted, while all the other components of the MEA 137 are retained. Thus, as shown in FIG. 20, the system 101 depicts such a modification of FIG. 1. In this configuration, the porous diaphragm is non-selective and permits passage of cations and anions.

As a result, the MEA 137 now comprises a single ion-exchange membrane, namely IEM2 120, which hence separates the posolyte and the negolyte. Further, the absence of the membrane IEM1 115 means that because of the resulting free diffusive transport of both anions and cations across the negative porous electrode 125 to the NL 110, there is no necessity for provisioning for convective or pump transport of the CO₂-bearing anions or other negolyte ingredients to the NL 110, and hence there is no need for the corresponding plumbing (FIG. 1). However, a mechanism for CO₂ removal (180) is still needed.

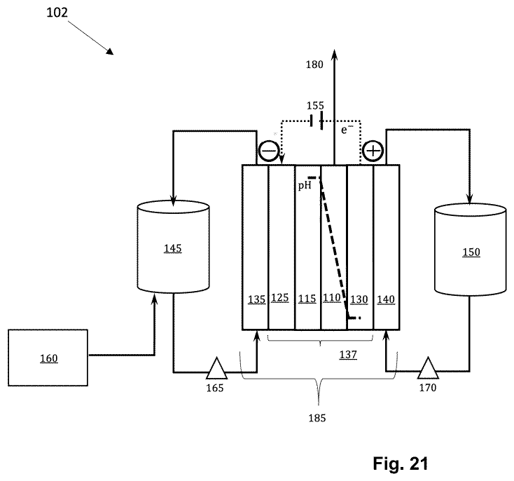

FIG. 21 shows an alternative configuration 102 employing a single ion-exchange membrane in the membrane-electrode assembly (MEA) adjacent the negative electrolyte membrane-electrode assembly (MEA). In this configuration of a single membrane cell 102, the IEM2 120 is absent, while all the other components of the MEA37, including IEM1 115, are retained. Thus, as shown in FIG. 21, the MEA37 is now comprised of the single ion-exchange membrane, IEM2 120. More specifically, the ion exchange membrane may be disposed between the neutralyte layer and the negative electrode, or the ion exchange membrane may be disposed between the neutralyte layer and the positive electrode.

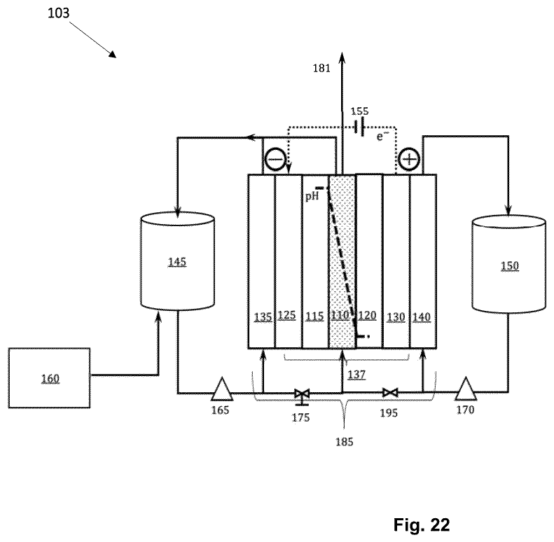

FIG. 22 shows a configuration where the neutralyte is formed from a porous catalytic material to produce a chemical or fuel. Referring to FIG. 22, in another proposed embodiment, the neutralyte layer 110 is not simply a separator layer comprised of a porous inert polymer or a ceramic material. Rather, the NL may be comprised of a porous layer of catalytic material for facilitating desired reactions, for instance for converting CO₂ bearing anions directly into a desired chemical or a fuel 181. A schematic of this proposed embodiment 103 for the general case of the original system (FIG. 1), i.e., with both IEMs 115 and 120, is shown.

In the approach of FIG. 22, the neutralyte layer 110 further comprises a porous catalytic material, such that the porous catalytic material is selected based on an ability to react with at least one of the alkaline negative electrolyte 135 or acidic positive electrolyte 140. The porous catalytic material is disposed adjacent an ion-exchange membrane 115, such that the ion-exchange membrane is in turn disposed between the porous catalytic material and the positive electrode, and the ion exchange membrane configured to pass protons for reacting with the CO₂-bearing anions facilitated by the porous catalytic material.

Such a catalyst may, for instance, facilitate a reaction between the CO₂ bearing anions and protons coming across IEM2 120, as well as any additional reactants that may be included within the neutralyte to directly produce desired chemicals and fuels 181, rather than first recovering pure CO₂ from these anions.

As an example of application of this embodiment, the following catalytic reaction may occur during the charge phase of the cell:

$${H}^{+} + {HCO}_{3}^{-} + {CH}_{3} OH ⇄ {H}_{2} O + {HCOOCH}_{3}$$

where methanol is included in the neutralyte as a co-reactant, along with CO₂ bearing anions, to catalytically produce methyl formate. Numerous other examples of such direct catalytic synthesis from the CO₂ bearing anions may be implemented.

As a further example, the catalyst included in the NL may be utilized for assisting in the water dissociation reaction that occurs during the discharge phase of the cell, i.e.,

$${H}_{2} O ⇄ {H}^{+} + {OH}^{-}$$

needed for replenishing the pH differential during a charge-discharge cycle.

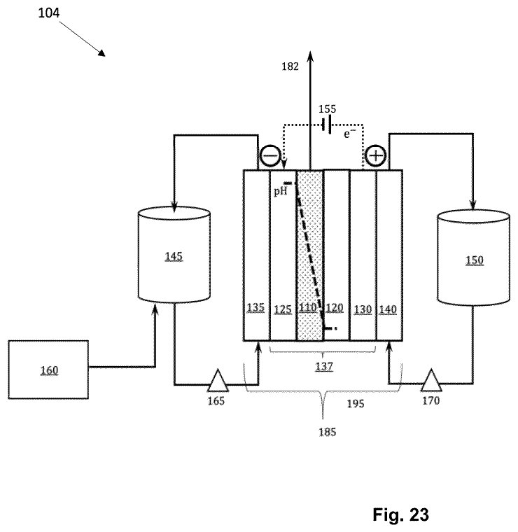

FIG. 23 shows a single ion exchange membrane (IEM) in conjunction with a neutralyte formed from a porous electrocatalytic material. Referring to FIG. 23, an alternative embodiment is disclosed for the electrocatalytic conversion of CO₂ bearing anions, when either the IEM1 115 or the IEM2 120 (FIG. 20 or 21) is absent and hence the NL is in direct contact with the electrode, 125 or 130, so that electron transfer and hence electrocatalysis in the NL is possible. In FIG. 23, the neutralyte layer 110 further comprises a porous electrocatalytic material selected based on an ability to react with the CO₂-bearing anions. This example of such an embodiment 104 when IEM1 115 is removed is shown in FIG. 23.

As a specific example of the application of this embodiment 104, consider the electrocatalytic formation of a formate ion, e.g., over a Bi electrocatalyst in the NL

$${HCO}_{3}^{-} + 2 {H}^{+} + 2 {e}^{-} ⇄ {H}_{2} O + {HCOO}^{-}$$

Numerous other examples of such direct electrochemical synthesis from the CO₂ bearing anions may also be achieved.

Although not shown schematically here, an alternative electrocatalytic scheme is possible when IEM2 120 (FIG. 21) is removed and the NL 110 is comprised of a porous electrocatalytic material.

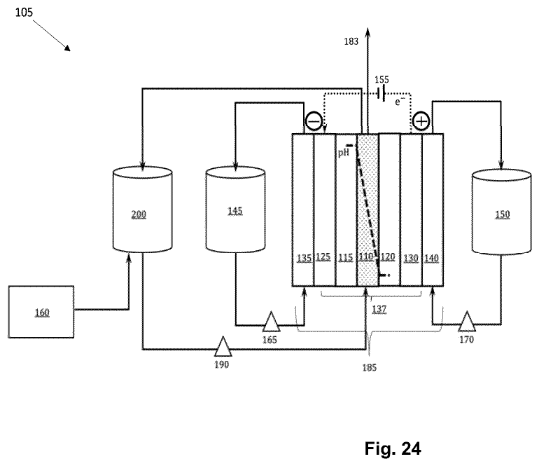

FIG. 24 shows an enhancement wherein the negolyte and the neutralyte are distinct electrolytes and the negolyte is not in fluid communication with gas-liquid CO₂ absorber. In an alternative embodiment 105 of FIG. 24, the negolyte 135 and the neutralyte 110 are not the same but rather are chemically distinct electrolytes, such that the negative electrolyte and the neutralyte comprise different substances and the negative electrolyte is in communication with a waste CO₂ source. Thus, the neutralyte contains the ions bearing CO₂ captured in the external gas-liquid absorber 160, while the negolyte contains redox materials but no CO₂ bearing ions. It may be recalled that in the original invention the negolyte storage tank 145 is connected to the gas-liquid absorber 160 (or alternatively has CO₂ bubbling through the liquid neutralyte in tank 145) and hence contains the same electrolyte as in 160. In the proposed new embodiment, the electrolyte bearing the CO₂ bearing anions is stored separately in the neutralyte storage tank 200 and is pumped directly to the NL 110, which may or may not be catalytic. The negolyte which does not contain the CO₂ bearing anions is stored in negolyte tank 145, and is not in fluid communication with the gas-liquid absorber 160.

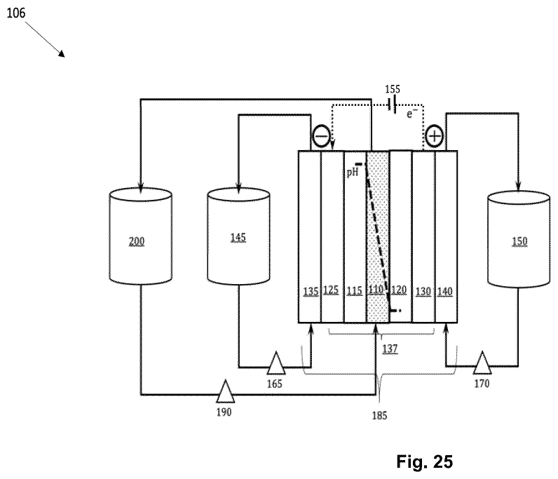

FIG. 25 shows an approach 106 employing 2 opposed ion-exchange membranes and adapted for use exclusively for energy storage (ES) without carbon capture (CC). In the alternative embodiment of FIG. 25, the CO₂ bearing anions are absent, and the approach is used exclusively for energy storage (ES), and not for carbon capture (CC). This means that the external gas-liquid absorber 160 is absent, as is the outlet 180 for releasing the pure CO₂, or indeed any chemical or fuel produced from it. The hence modified redox-flow battery (RFB) system is shown in FIG. 25. with the original MEA 137 structure containing both IEM1 115 and IEM2 120. Thus, the alkaline negative electrolyte and the acidic positive electrolyte embrace redox active molecules that participate in redox reactions to store electrical energy, but need not employ or require CO₂ in the respective reactions.

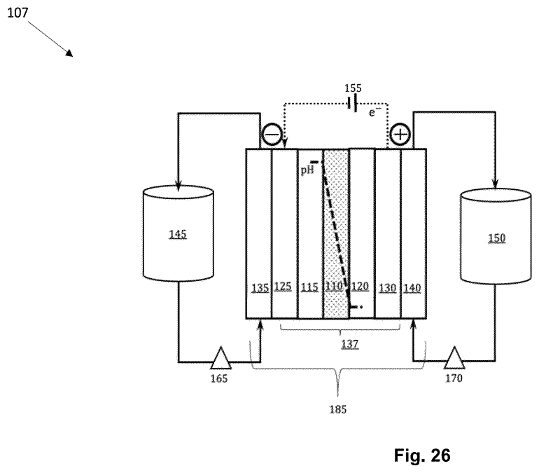

FIG. 26 shows a variation of the approach of FIG. 1 without a separate neutralyte and used exclusively for energy storage (ES) without carbon capture (CC). This shows an embodiment of the RFB in FIG. 25 for exclusive energy storage or battery function, a separate neutralyte is not utilized. The neutralyte tank 200 and the associated plumbing shown in FIG. 25 are absent.

In the configuration 107 of FIG. 26, also designed for exclusive energy storage or battery function, the cell may further contain only a single IEM, namely, IEM1 115 or IEM2 120. Of course, a separate neutralyte would then also not be needed, and the neutralyte tank 200 and the associated plumbing shown in FIG. 25 would be absent. The example of a cell when only IEM2 120 is included, but IEM1 115 is absent, is shown in FIG. 26. Alternatively, of course, IEM1 115 may be retained, with IEM2 120 being absent.

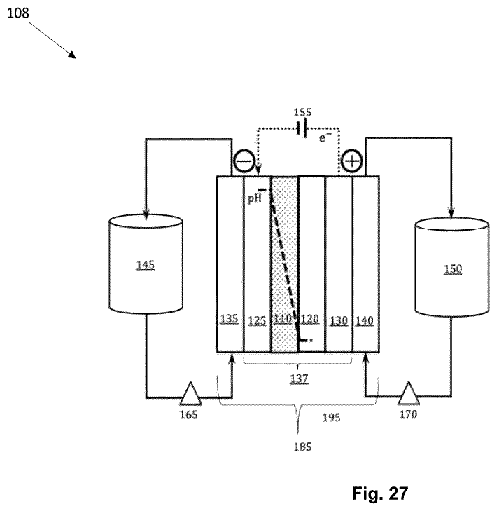

FIG. 27 shows a configuration 108 as in FIG. 26 with only a single ion-exchange membrane, also used exclusively for energy storage (ES) or as a flow battery without carbon capture (CC). In FIG. 27, during the discharge cycle of the RFB cell shown in FIG. 26, since CO₂ is not involved, the reactions are:

| Electrode | Reaction |
|---|---|
| Negative, | O_ + AOH + e⁻ [symbol] R_ + OH⁻ |
| NL | H+ + OH⁻ [symbol] H₂O |
| Positive, | R₊ [symbol] O₊ + H⁺ + e⁻ |
| Cell OR: | O__+ AOH + R+ [symbol] _ R__+ H₂O + O₊ |

while during the discharge cycle the reactions are:

| Electrode | Reaction |
|---|---|
| Negative, | R_+ OH⁻ [symbol] O_ + AOH + e⁻ |
| NL, | H₂O [symbol] H⁺ + OH⁻ |
| Positive, | O₊ + H⁺ + e⁻ [symbol] R₊ |
| Cell OR: | R_ + H₂O + O+ [symbol] O_+ AOH + R₊ |

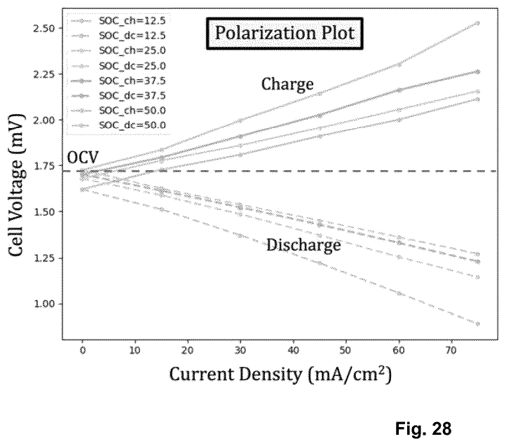

An exemplary polarization plot of such a cell is provided in FIG. 28, wherein both the redox couple in the negolyte, R₋/O₋, and that in the posolyte, R₊/O₊, are based on iron. The pH differential in the cell allows this cell to accomplish an open circuit voltage (OCV) in excess of 1.5 V, which is normally the limit in aqueous-phase systems with a uniform pH.

FIG. 28 shows a polarization plot of an all-iron redox flow battery device at various states of charge (soc) during charge (ch) and discharge (dc) phases.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A flow electrochemical cell device comprising:
a pair of opposed electrodes including:
a negative electrode configured to be in fluid communication with an alkaline negative electrolyte for producing CO₂-bearing anions; and
a positive electrode configured to be in fluid communication with an acidic positive electrolyte,
the alkaline negative electrolyte and the acidic positive electrolyte further comprising redox active molecules that participate in redox reactions to store electrical energy;
at least one porous diaphragm or ion exchange membrane in contact with an opposed electrode of the pair of opposed electrodes; and
an intermediate neutralyte layer adjacent the porous diaphragm and between the pair of opposed electrodes,
the porous diaphragm and the neutralyte layer configured to maintain a pH differential between the negative electrode and the positive electrode based on the redox reactions.

2. The device of claim 1 wherein the porous diaphragm is non-selective and permits passage of cations and anions.

3. The device of claim 1 wherein the porous diaphragm further comprises an ion-exchange membrane adapted for selective diffusion.

4. The device of claim 1 further comprising an ion-exchange membrane adjacent the neutralyte layer on an opposed side of the neutralyte layer from the ion-exchange membrane.

5. The device of claim 3 further comprising a second ion-exchange membrane adjacent the neutralyte layer on an opposed side of the neutralyte layer from the first ion-exchange membrane.

6. The device of claim 1 wherein the pH differential forms across the neutralyte layer.

7. The device of claim 2 wherein the ion exchange membrane is disposed between the neutralyte layer and the negative electrode.

8. The device of claim 2 wherein the ion exchange membrane is disposed between the neutralyte layer and the positive electrode.

9. The device of claim 1, further comprising a connection from the positive and negative electrodes to an electric load, wherein the pH differential results in a difference in potential between the positive electrode and the negative electrode for forming a current flow to the electric load.

10. The device of claim 1, wherein the neutralyte layer further comprises a porous catalytic material, the porous catalytic material selected based on an ability to react with at least one of the alkaline negative electrolyte or acidic positive electrolyte.

11. The device of claim 10 wherein the porous catalytic material is disposed adjacent an ion-exchange membrane, the ion-exchange membrane disposed between the porous catalytic material and the positive electrode, the ion exchange membrane configured to pass protons for reacting with the CO₂-bearing anions facilitated by the porous catalytic material.

12. The device of claim 1, wherein the neutralyte layer further comprises a porous electrocatalytic material, the porous electrocatalytic material selected based on an ability to react with the CO2-bearing anions.

13. The device of claim 1 wherein the negative electrolyte and the neutralyte share a common source from a storage tank, the storage tank in communication with a waste CO₂ source.

14. The device of claim 1 wherein the negative electrolyte and the neutralyte comprise different substances and the negative electrolyte is in communication with a waste CO₂ source.

15. A flow electrochemical cell device comprising:
a pair of opposed electrodes including:
a negative electrode configured to be in fluid communication with alkaline negative electrolyte; and
a positive electrode configured to be in fluid communication with an acidic positive electrolyte,
the alkaline negative electrolyte and the acidic positive electrolyte further comprising redox active molecules that participate in redox reactions to store electrical energy;
an ion-exchange membrane in contact with an opposed electrode of the pair of opposed electrodes; and
an intermediate neutralyte layer adjacent the ion-exchange membrane and between the pair of opposed electrodes,
the ion-exchange membrane configured to maintain a pH differential between the negative electrode and the positive electrode based on the redox reactions.

16. The device of claim 15 further comprising:
a fluidic connection supplying and circulating the alkaline negative electrolyte; and
a fluidic connection supplying and circulating the acidic positive electrolyte.
